(19) United States
(12) Patent Application Publication
(10) Pub. No.: US 2023/0113736 A1
(43) Pub. Date: Apr. 13, 2023

(54) IMAGE PROCESSING APPARATUS AND METHOD

(71) Applicant: SONY GROUP CORPORATION, Tokyo (JP)

(72) Inventors: Koji YANO, Tokyo (JP); Satoru KUMA, Tokyo (JP); Ohji NAKAGAMI, Tokyo (JP); Kao HAYASHI, Kanagawa (JP); Hiroyuki YASUDA, Saitama (JP); Tsuyoshi KATO, Kanagawa (JP)

(73) Assignee: SONY GROUP CORPORATION, Tokyo (JP)

(21) Appl. No.: 17/912,420

(22) PCT Filed: Mar. 11, 2021
(86) PCT No.: PCT/JP2021/009734

§ 371 Date: Sep. 16, 2022

(30) Foreign Application Priority Data
Mar. 25, 2020 (JP) 2020-053702

(51) Int. Cl. G06T 9/00

(52) U.S. Cl. CPC G06T 9/001; G06T 2219/008

(57) ABSTRACT

There is provided an image processing apparatus and a method that enable suppression of an increase in load of decoding of a point cloud. Auxiliary patch information being information regarding a patch obtained by projecting a point cloud representing a three-dimensional shaped object as an aggregate of points, onto a two-dimensional plane for each partial region is generated in such a manner as to correspond to all of a plurality of frames included in a predetermined section in a time direction of the point cloud, a patch is generated using the generated auxiliary patch information for each frame in the section, and a frame image in which the generated patch is arranged is encoded. The present disclosure can be applied to, for example, an image processing apparatus, an electronic device, an image processing method, a program, or the like.

### TECHNICAL FIELD

The present disclosure relates to an image processing apparatus and a method, and relates particularly to an image processing apparatus and a method that enable suppression of an increase in load of decoding of a point cloud.

### BACKGROUND ART

The standardization of encoding and decoding of point cloud data representing a three-dimensional shaped object as an aggregate of points has been conventionally promoted by the Moving Picture Experts Group (MPEG) (for example, refer to Non-Patent Document 1).

Furthermore, there has been proposed a method (hereinafter, will also be referred to as video-based approach) of projecting geometry data and attribute data of a point cloud onto a two-dimensional plane for each small region, arranging an image (patch) projected on the two-dimensional plane, into a frame image, and encoding the frame image using an encoding method for two-dimensional images (for example, refer to Non-Patent Documents 2 to 4).

### CITATION LIST

### Non-Patent Document

Non-Patent Document 1: “Information technology - MPEG-I (Coded Representation of Immersive Media) - Part 9: Geometry-based Point Cloud Compression”, ISO/IEC 23090-9:2019(E)

Non-Patent Document 2: Tim Golla and Reinhard Klein, “Real-time Point Cloud Compression”, IEEE, 2015

Non-Patent Document 3: K. Mammou, “Video-based and Hierarchical Approaches Point Cloud Compression”, MPEG m41649, October 2017

Non-Patent Document 4: K. Mammou, “PCC Test Model Category 2 v0”, N17248 MPEG output document, October 2017

### SUMMARY OF THE INVENTION

### Problems to Be Solved by the Invention

In the case of the video-based approach described in Non-Patent Documents 2 to 4, it has been necessary to transmit auxiliary patch information being information regarding a patch, for each frame, and load applied on a decoding side might be increased by processing of the auxiliary patch information.

The present disclosure has been devised in view of such a situation, and enables suppression of an increase in load of decoding of a point cloud.

### Solutions to Problems

An image processing apparatus according to an aspect of the present technology includes an auxiliary patch information generation unit configured to generate auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud, a patch generation unit configured to generate, for each frame in the section, the patch using the auxiliary patch information generated by the auxiliary patch information generation unit, and an encoding unit configured to encode a frame image in which the patch generated by the patch generation unit is arranged.

An image processing method according to an aspect of the present technology includes generating auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud, generating, for each frame in the section, the patch using the generated auxiliary patch information, and encoding a frame image in which the generated patch is arranged.

An image processing apparatus according to another aspect of the present technology includes an auxiliary patch information holding unit configured to hold auxiliary patch information being information regarding a patch obtained by projecting a point cloud representing a three-dimensional shaped object as an aggregate of points, onto a two-dimensional plane for each partial region that has been used in generation of the patch, a patch generation unit configured to generate the patch of a processing target frame of the point cloud using the auxiliary patch information corresponding to the processing target frame, or the auxiliary patch information corresponding to a past frame of the point cloud being a frame processed in a past that is held in the auxiliary patch information holding unit, and an encoding unit configured to encode a frame image in which the patch generated by the patch generation unit is arranged.

An image processing method according to another aspect of the present technology includes holding auxiliary patch information being information regarding a patch obtained by projecting a point cloud representing a three-dimensional shaped object as an aggregate of points, onto a two-dimensional plane for each partial region that has been used in generation of the patch, generating the patch of a processing target frame of the point cloud using the auxiliary patch information corresponding to the processing target frame, or the held auxiliary patch information corresponding to a past frame of the point cloud being a frame processed in a past, and encoding a frame image in which the generated patch is arranged.

An image processing apparatus according to yet another aspect of the present technology includes an auxiliary patch information decoding unit configured to decode coded data and generate auxiliary patch information being information regarding a patch obtained by projecting a point cloud representing a three-dimensional shaped object as an aggregate of points, onto a two-dimensional plane for each partial region, an auxiliary patch information holding unit configured to hold the auxiliary patch information generated by the auxiliary patch information decoding unit, and a reconstruction unit configured to reconstruct the point cloud of a plurality of frames using the mutually-identical auxiliary patch information held in the auxiliary patch information holding unit.

An image processing method according to yet another aspect of the present technology includes decoding coded data and generating auxiliary patch information being information regarding a patch obtained by projecting a point cloud representing a three-dimensional shaped object as an aggregate of points, onto a two-dimensional plane for each partial region, holding the generated auxiliary patch information, and reconstructing the point cloud of a plurality of frames using the held mutually-identical auxiliary patch information.

In the image processing apparatus and the method according to an aspect of the present technology, auxiliary patch information being information regarding a patch obtained by projecting a point cloud representing a three-dimensional shaped object as an aggregate of points, onto a two-dimensional plane for each partial region is generated in such a manner as to correspond to all of a plurality of frames included in a predetermined section in a time direction of the point cloud, a patch is generated using the generated auxiliary patch information for each frame in the section, and a frame image in which the generated patch is arranged is encoded.

In the image processing apparatus and the method according to another aspect of the present technology, auxiliary patch information being information regarding a patch obtained by projecting a point cloud representing a three-dimensional shaped object as an aggregate of points, onto a two-dimensional plane for each partial region that has been used in generation of the patch is held, and a patch of a processing target frame of the point cloud is generated using the auxiliary patch information corresponding to the processing target frame, or the held auxiliary patch information corresponding to a past frame of the point cloud being a frame processed in a past, and a frame image in which the generated patch is arranged is encoded.

In the image processing apparatus and the method according to yet another aspect of the present technology, coded data is decoded, auxiliary patch information being information regarding a patch obtained by projecting a point cloud representing a three-dimensional shaped object as an aggregate of points, onto a two-dimensional plane for each partial region is generated, the generated auxiliary patch information is held, and the point cloud of a plurality of frames is reconstructed using the held mutually-identical auxiliary patch information.

### BRIEF DESCRIPTION OF DRAWINGS

FIG. 1 is a diagram describing data of video-based approach.

FIG. 2 is a diagram describing auxiliary patch information.

FIG. 3 is a diagram describing a generation method of auxiliary patch information.

FIG. 4 is a diagram describing Method 1.

FIG. 5 is a diagram describing Method 2.

FIG. 6 is a diagram illustrating an example of a syntax of auxiliary patch information.

FIG. 7 is a diagram illustrating an example of semantics of auxiliary patch information.

FIG. 8 is a diagram illustrating an example of semantics of auxiliary patch information.

FIG. 9 is a block diagram illustrating a main configuration example of an encoding device.

FIG. 10 is a flowchart describing an example of a flow of encoding processing.

FIG. 11 is a flowchart describing an example of a flow of encoding processing.

FIG. 12 is a block diagram illustrating a main configuration example of a decoding device.

FIG. 13 is a flowchart describing an example of a flow of decoding processing.

FIG. 14 is a block diagram illustrating a main configuration example of an encoding device.

FIG. 15 is a flowchart describing an example of a flow of encoding processing.

FIG. 16 is a block diagram illustrating a main configuration example of an encoding device.

FIG. 17 is a flowchart describing an example of a flow of encoding processing.

FIG. 18 is a flowchart describing an example of a flow of encoding processing that follows FIG. 17.

FIG. 19 is a flowchart describing an example of a flow of decoding processing.

FIG. 20 is a block diagram illustrating a main configuration example of an encoding device.

FIG. 21 is a flowchart describing an example of a flow of encoding processing.

FIG. 22 is a flowchart describing an example of a flow of decoding processing.

FIG. 23 is a diagram describing an example of an image processing system.

FIG. 24 is a diagram illustrating a main configuration example of an image processing system.

FIG. 25 is a diagram illustrating a main configuration example of a server.

FIG. 26 is a diagram illustrating a main configuration example of a client.

FIG. 27 is a flowchart describing an example of a flow of data transmission processing.

FIG. 28 is a block diagram illustrating a main configuration example of a computer.

### MODE FOR CARRYING OUT THE INVENTION

Hereinafter, a mode for carrying out the present disclosure (hereinafter, referred to as an embodiment) will be described. Note that the description will be given in the following order.
1. Auxiliary Patch Information
2. First Embodiment (Method 1)
3. Second Embodiment (Method 2)
4. Third Embodiment (Method 3-1)
5. Fourth Embodiment (Method 3-2)
6. Fifth Embodiment (System Example 1 to Which Present Technology Is Applied)
7. Sixth Embodiment (System Example 2 to Which Present Technology Is Applied)
8. Additional Statement

### 1. Auxiliary Patch Information

### Documents, Etc. That Support Technical Content and Technical Term

The scope disclosed in the present technology is not limited to the content described in embodiments, and also includes the content described in the following Non-Patent Documents and the like that have become publicly-known at the time of application, and the content and the like of other documents referred to in the following Non-Patent Documents.

Non-Patent Document 1: (mentioned above) Non-Patent Document 2: (mentioned above) Non-Patent Document 3: (mentioned above) Non-Patent Document 4: (mentioned above) Non-Patent Document 5: Kangying CAI, Vladyslav Zakharcchenko, Dejun ZHANG, “[VPCC] [New proposal] Patch skip mode syntax proposal”, ISO/IEC JTC1/SC29/WG11 MPEG2019/ m47472, March 2019, Geneva, CH Non-Patent Document 6: “Text of ISO/IEC DIS 23090-5 Video-based Point Cloud Compression”, ISO/IEC JTC 1/SC 29/WG 11 N18670, 2019-10-10 Non-Patent Document 7: Danillo Graziosi and Ali Tabatabai, “[V-PCC] New Contribution on Patch Coding”, ISO/IEC JTC1/SC29/WG11 MPEG2018/ m47505, March 2019, Geneva, CH

That is, the content described in Non-Patent Documents mentioned above, and the content and the like of other documents referred to in Non-Patent Documents mentioned above also serve as basis in determining support requirements.

### Point Cloud

Three-dimensional (3D) data such as a point cloud that represents a three-dimensional structure using positional information, attribute information, and the like of points has conventionally existed.

For example, the point cloud represents a three-dimensional structure (three-dimensional shaped object) as an aggregate of a number of points. Data of the point cloud (will also be referred to as point cloud data) includes positional information (will also be referred to as geometry data) and attribute information (will also be referred to as attribute data) of each point. The attribute data can include arbitrary information. For example, the attribute data may include color information, reflectance ratio information, normal information, and the like of each point. In this manner, the point cloud data can represent an arbitrary three-dimensional structure with sufficient accuracy by having a relatively simple data structure, and using a sufficiently large number of points.

### Quantization of Positional Information That Uses Voxel

Because such point cloud data has a relatively large data amount, for compressing a data amount obtained by encoding or the like, an encoding method that uses voxels has been considered. The voxel is a three-dimensional region for quantizing geometry data (positional information).

That is, a three-dimensional region (will also be referred to as a bounding box) encompassing a point cloud is divided into small three-dimensional regions called voxels, and each of the voxels indicates whether or not a point is encompassed. The position of each point is thereby quantized for each voxel. Accordingly, by converting point cloud data into such data of voxels (will also be referred to as voxel data), an increase in information amount can be suppressed (typically, an information amount can be reduced).

### Overview of Video-Based Approach

In the video-based approach, geometry data and attribute data of such a point cloud are projected onto a two-dimensional plane for each small region. An image in which the geometry data and the attribute data are projected on the two-dimensional plane will also be referred to as a projected image. Furthermore, a projected image of each small region will be referred to as a patch. For example, in a projected image (patch) of geometry data, positional information of a point is represented as positional information (depth) in a vertical direction (depth direction) with respect to a projection surface.

Then, each patch generated in this manner is arranged in a frame image. A frame image in which patches of geometry data are arranged will also be referred to as a geometry video frame. Furthermore, a frame image in which patches of attribute data are arranged will also be referred to as a color video frame. For example, each pixel value of a geometry video frame indicates the aforementioned depth.

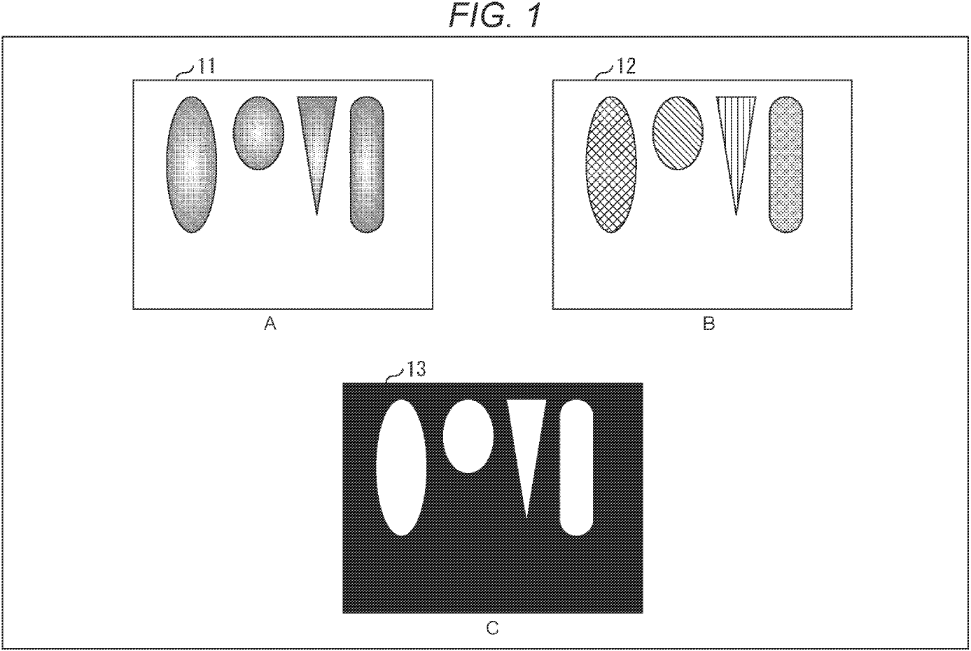

That is, in the case of video-based approach, a geometry video frame 11 in which patches of geometry data are arranged as illustrated in A of FIG. 1, and a color video frame 12 in which patches of attribute data are arranged as illustrated in B of FIG. 1 are generated.

Then, these video frames are encoded using an encoding method for two-dimensional images such as Advanced Video Coding (AVC) or High Efficiency Video Coding (HEVC), for example. That is, point cloud data being 3D data representing a three-dimensional structure can be encoded using a codec for two-dimensional images.

### Occupancy Map

Note that, in the case of such video-based approach, an occupancy map 13 as illustrated in C of FIG. 1 can also be further used. The occupancy map is map information indicating the existence or non-existence of a projected image (patch) every N x N pixels of a geometry video frame. For example, the occupancy map 13 indicates a value “1” for a region (N x N pixels) of the geometry video frame 11 or the color video frame 12 in which patches exists, and indicates a value “0” for a region (N x N pixels) in which a patch does not exist.

Such an occupancy map is encoded as data different from a geometry video frame and a color video frame, and transmitted to the decoding side. Because a decoder can recognize whether or not a target region is a region in which a patch exists, by referring to the occupancy map, the influence of noise or the like that is caused by encoding or decoding can be suppressed, and 3D data can be restored more accurately. For example, even if a depth varies due to encoding or decoding, by referring to the occupancy map, the decoder can ignore a depth of a region in which a patch does not exist (avoid processing the region as positional information of 3D data).

Note that, similarly to the geometry video frame 11, the color video frame 12, and the like, the occupancy map 13 can also be transmitted as a video frame (that is, can be encoded or decoded using a codec for two-dimensional images).

### Moving Image

In the following description, (an object of) a point cloud can vary in a time direction like a moving image of two-dimensional images. That is, geometry data and attribute data include the concept of the time direction, and are assumed to be data sampled every predetermined time like a moving image of two-dimensional images. Note that, like a video frame of a two-dimensional image, data at each sampling time will be referred to as a frame. That is, point cloud data (geometry data and attribute data) includes a plurality of frames like a moving image of two-dimensional images. Note that, for the sake of explanatory convenience, patches of geometry data or attribute data of each frame are assumed to be arranged in one video frame unless otherwise stated.

### Auxiliary Patch Information

As described above, in the case of video-based approach, 3D data is converted into patches, and the patches are arranged in a video frame and encoded using a codec for two-dimensional images. Information (will also be referred to as auxiliary patch information) regarding the patches is therefore transmitted as metadata. Because the auxiliary patch information is neither image data nor map information, the auxiliary patch information is transmitted to the decoding side as information different from the aforementioned video frames. That is, for encoding or decoding the auxiliary patch information, a codec not intended for two-dimensional images is used.

Therefore, while coded data of video frames such as the geometry video frame 11, the color video frame 12, and the occupancy map 13 can be decoded using a codec for two-dimensional images of a graphics processing unit (GPU), coded data of auxiliary patch information needs to be decoded using a central processing unit (CPU) used also for other processing, and load might be increased by processing of the auxiliary patch information.

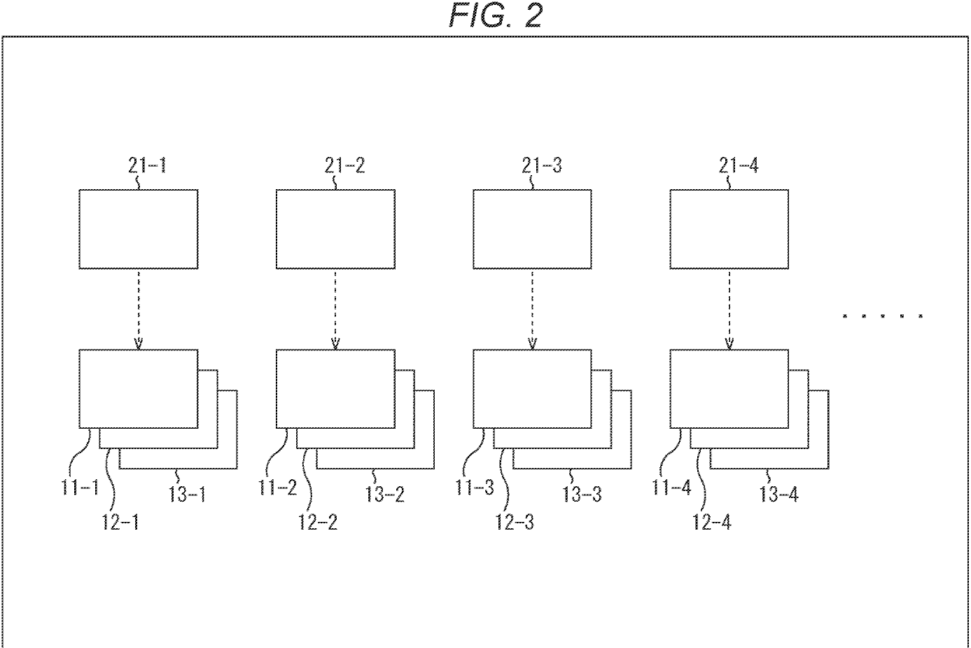

Furthermore, auxiliary patch information is generated for each frame as illustrated in FIG. 2 (auxiliary patch information pieces 21-1 to 21-4). Therefore, auxiliary patch information needs to be decoded for each frame, and an increase in load might become more prominent. Note that, for example, Non-Patent Document 5 discloses a skip patch that uses patch information of another patch, but this is control to be performed for each patch, and control becomes complicated. It has been therefore difficult to suppress an increase in load.

Moreover, for reconstructing 3D data, it has been necessary to combine auxiliary patch information to be decoded in a CPU, and geometry data and the like that are to be decoded in a GPU. At this time, it is necessary to correctly associate auxiliary patch information with geometry data, attribute data, and occupancy map of a frame to which the auxiliary patch information corresponds. That is, it is necessary to correctly achieve synchronization between these pieces of data to be processed by mutually-different processing units, and processing load might accordingly increase.

For example, in the case of FIG. 2, the auxiliary patch information 21-1 needs to be associated with a geometry video frame 11-1, a color video frame 12-1, and an occupancy map 13-1, the auxiliary patch information 21-2 needs to be associated with a geometry video frame 11-2, a color video frame 12-2, and an occupancy map 13-2, the auxiliary patch information 21-3 needs to be associated with a geometry video frame 11-3, a color video frame 12-3, and an occupancy map 13-3, and the auxiliary patch information 21-4 needs to be associated with a geometry video frame 11-4, a color video frame 12-4, and an occupancy map 13-4.

### Application of Auxiliary Patch Information to Plurality of Frames

Therefore, in each of a plurality of frames, mutually-identical auxiliary patch information is applied to reconstruction of 3D data. With this configuration, the number of pieces of auxiliary patch information can be reduced. Therefore, an increase in load applied by the processing of auxiliary patch information can be suppressed.

### Method 1

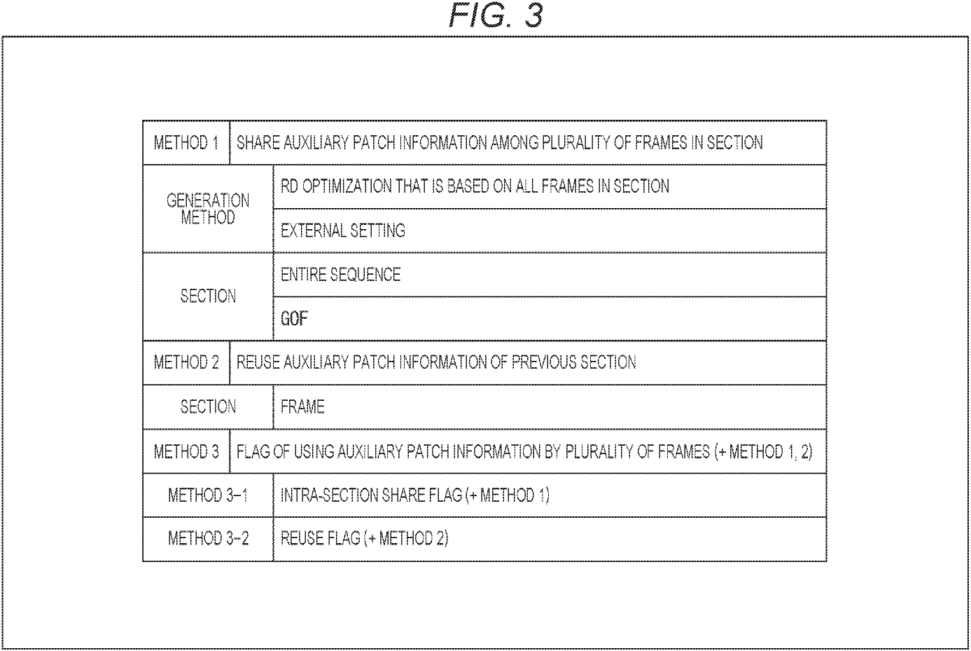

For example, as in “Method 1” illustrated in a table in FIG. 3, auxiliary patch information may be shared in a “section” including a plurality of frames.

In other words, auxiliary patch information being information regarding a patch obtained by projecting a point cloud representing a three-dimensional shaped object as an aggregate of points, onto a two-dimensional plane for each partial region may be generated in such a manner as to correspond to all of a plurality of frames included in a predetermined section in a time direction of the point cloud, a patch may be generated using the generated auxiliary patch information for each frame in the section, and a frame image in which the generated patch is arranged may be encoded.

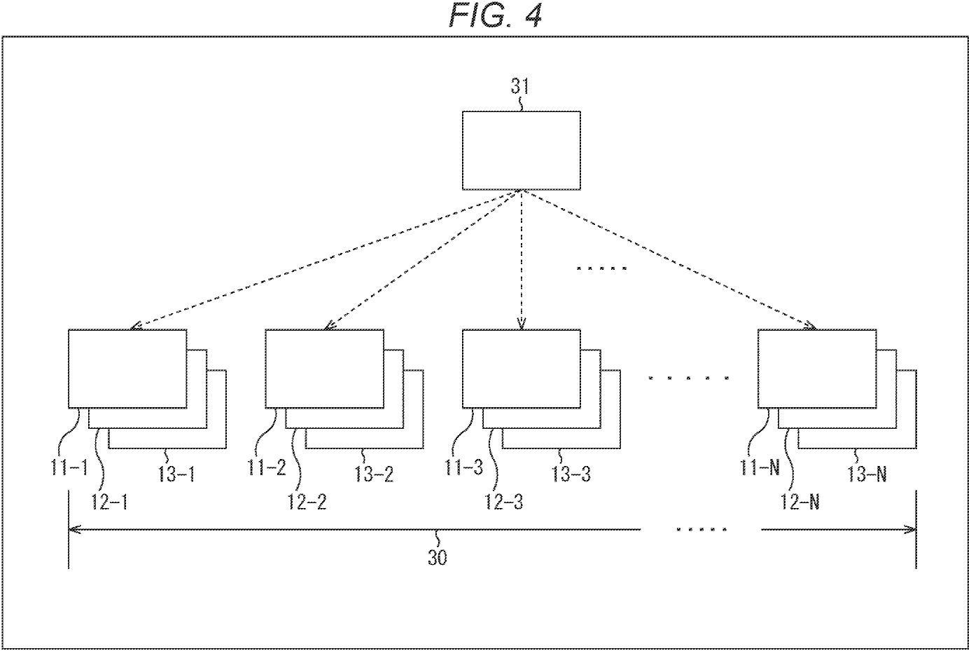

For example, as illustrated in FIG. 4, auxiliary patch information 31 corresponding to all frames included in a predetermined section 30 in the time direction of a point cloud including a plurality of frames is generated, and processing of each frame in the section 30 is performed using the auxiliary patch information 31. For example, in the case of FIG. 4, geometry video frames 11-1 to 11-N, color video frames 12-1 to 12-N, and occupancy maps 13-1 to 13-N are generated using the auxiliary patch information 31, and 3D data is reconstructed from these frames using the auxiliary patch information 31.

With this configuration, the number of pieces of auxiliary patch information to be transmitted can be reduced. That is, an information amount of auxiliary patch information to be transmitted can be reduced. Accordingly, an increase in load that is caused by decoding coded data of auxiliary patch information can be suppressed. Furthermore, because common auxiliary patch information is applied to frames in a section, it is sufficient that auxiliary patch information held in a memory is applied, and there is no need to achieve synchronization. Accordingly, it is possible to suppress an increase in load applied when 3D data is reconstructed.

Note that any generation method may be used as a generation method of auxiliary patch information corresponding to a plurality of frames in this manner. For example, auxiliary patch information may be generated (each parameter included in auxiliary patch information may be set) on the basis of all frames in a section. For example, RD optimization may be performed using information regarding each frame in a section, and auxiliary patch information may be generated (each parameter included in auxiliary patch information may be set) on the basis of a result thereof. Furthermore, each parameter included in auxiliary patch information may be set on the basis of a setting (external setting) input from the outside. With this configuration, auxiliary patch information corresponding to a plurality of frames can be generated more easily.

Furthermore, any section may be set as a section in which auxiliary patch information is shared, as long as the section falls within a range (data unit) in the time direction. For example, the entire sequence may be set as the section, or a group of frame (GOF) being an aggregate of a predetermined number of successive frames that are based on an encoding method (decoding method) may be set as the section.

### Method 2

For example, as in “Method 2” illustrated in the table in FIG. 3, auxiliary patch information of a previous section being a section processed in the past may be reused in a present section to be processed. For example, when one frame is regarded as a “section”, auxiliary patch information applied in a “previous section″(i.e., a frame processed in the past (will also be referred to as a past frame)) may be reused in a “present section″(i.e., processing target frame).

In other words, auxiliary patch information being information regarding a patch obtained by projecting a point cloud representing a three-dimensional shaped object as an aggregate of points, onto a two-dimensional plane for each partial region that has been used in the generation of the patch may be held, and a patch of a processing target frame of the point cloud may be generated using the auxiliary patch information corresponding to the processing target frame, or the held auxiliary patch information corresponding to a past frame of the point cloud being a frame processed in the past, and a frame image in which the generated patch is arranged may be encoded.

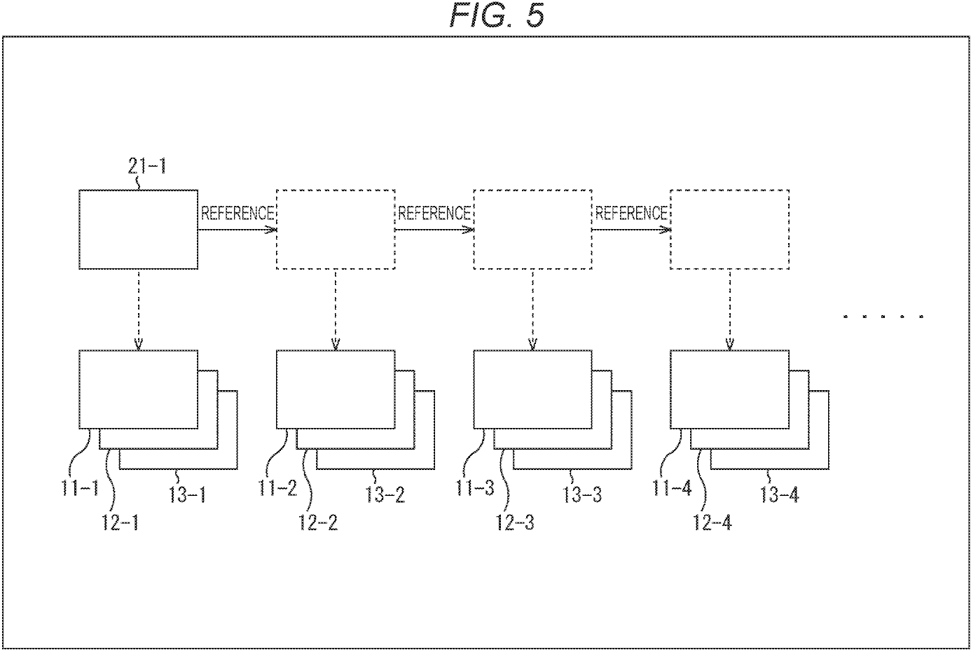

For example, as illustrated in FIG. 5, the geometry video frame 11-1, the color video frame 12-1, and the occupancy map 13-1 are processed using the auxiliary patch information 21-1. Next, when the geometry video frame 11-2, the color video frame 12-2, and the occupancy map 13-2 are processed, auxiliary patch information (i.e., the auxiliary patch information 21-1) used in the processing of an immediately preceding frame (the geometry video frame 11-1, the color video frame 12-1, and the occupancy map 13-1) is reused.

Similarly, when the geometry video frame 11-3, the color video frame 12-3, and the occupancy map 13-3 are processed, auxiliary patch information (i.e., the auxiliary patch information 21-1) used in the processing of an immediately preceding frame (the geometry video frame 11-2, the color video frame 12-2, and the occupancy map 13- 2) is reused. Similarly, when the geometry video frame 11-4, the color video frame 12- 4, and the occupancy map 13- 4 are processed, auxiliary patch information (i.e., the auxiliary patch information 21-1) used in the processing of an immediately preceding frame (the geometry video frame 11-3, the color video frame 12-3, and the occupancy map 13-3) is reused.

With this configuration, the number of pieces of auxiliary patch information to be transmitted can be reduced. That is, an information amount of auxiliary patch information to be transmitted can be reduced. Accordingly, an increase in load that is caused by decoding coded data of auxiliary patch information can be suppressed. Furthermore, it is sufficient that auxiliary patch information held in a memory (auxiliary patch information applied in the past) is applied, and there is no need to achieve synchronization. Accordingly, it is possible to suppress an increase in load applied when 3D data is reconstructed.

Note that the above description has been given of a configuration in which auxiliary patch information applied to a frame processed immediately before a processing target frame (that is, frame processed last) is reused, but the past frame may be a frame other than the immediately preceding frame. That is, the past frame may be a frame processed two or more frames ago. Furthermore, any section may be set as the aforementioned “section” as long as the section falls within a range (data unit) in the time direction, and is not limited to the aforementioned one frame. For example, a plurality of successive frames may be set as the “section”. For example, the entire sequence or a GOF may be set as the “section”. Moreover, the method described in <Method 1> and the method described in <Method 2> may be used in combination. For example, auxiliary patch information may be shared in a section, and auxiliary patch information of a “previous section” may be reused in a head frame of the section.

### Method 3

For example, as in “Method 3” illustrated in the table in FIG. 3, a flag indicating whether or not to use auxiliary patch information in a plurality of frames may be set. This “Method 3” can be applied in combination with “Method 1” or “Method 2” mentioned above.

For example, as in “Method 3-1” illustrated in the table in FIG. 3, a flag indicating whether or not to generate patches of each frame in a “section” using common auxiliary patch information may be set in combination with “Method 1”.

For example, when the set flag indicates that patches of each frame in a “section” are generated using common auxiliary patch information, in accordance with the flag, auxiliary patch information may be generated in such a manner as to correspond to all frames included in the section, and patches may be generated using the generated auxiliary patch information for each frame in the section.

Furthermore, for example, when the set flag indicates that patches of each frame in a “section” are generated using auxiliary patch information of a corresponding frame, auxiliary patch information may be generated for each of the frames included in the section, and patches may be generated for each of the frames in the section, using the generated auxiliary patch information corresponding to each frame.

With this configuration, a generation method of auxiliary patch information can be selected. Accordingly, a broader range of specifications can be supported.

Furthermore, for example, as in “Method 3-2” illustrated in the table in FIG. 3, a flag indicating whether or not to generate patches of a processing target frame using auxiliary patch information corresponding to a past frame may be set in combination with “Method 2”.

For example, when the set flag indicates that patches of a processing target frame are generated using auxiliary patch information corresponding to a past frame, patches of a processing target frame may be generated using auxiliary patch information corresponding to a past frame.

For example, when the set flag indicates that patches of a processing target frame are not generated using auxiliary patch information corresponding to a past frame, auxiliary patch information corresponding to a processing target frame may be generated, and patches of the processing target frame may be generated using the generated auxiliary patch information.

With this configuration, a generation method of auxiliary patch information can be selected. Accordingly, a broader range of specifications can be supported.

### Auxiliary Patch Information

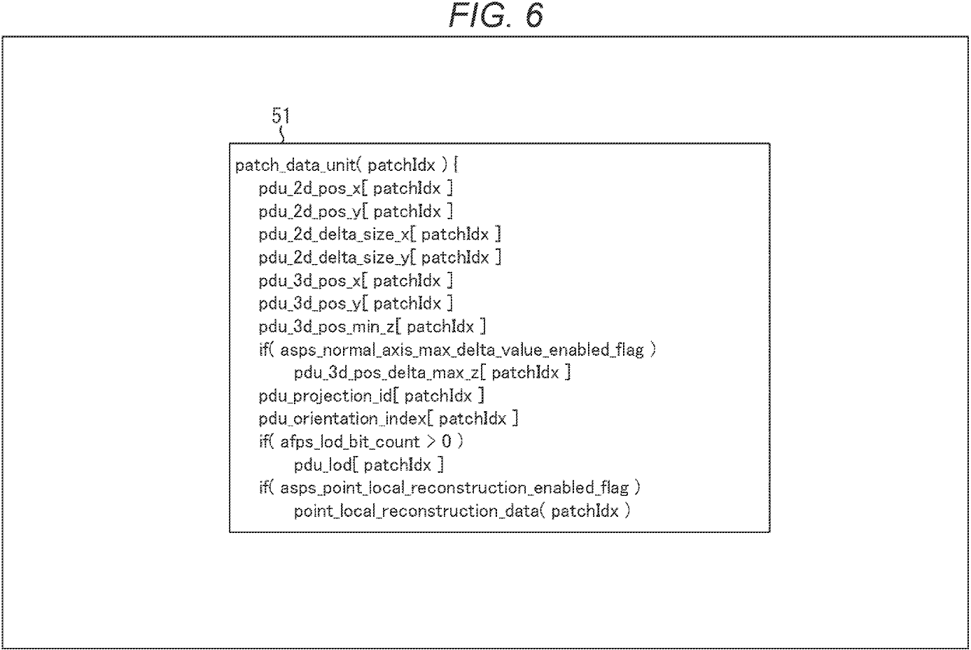

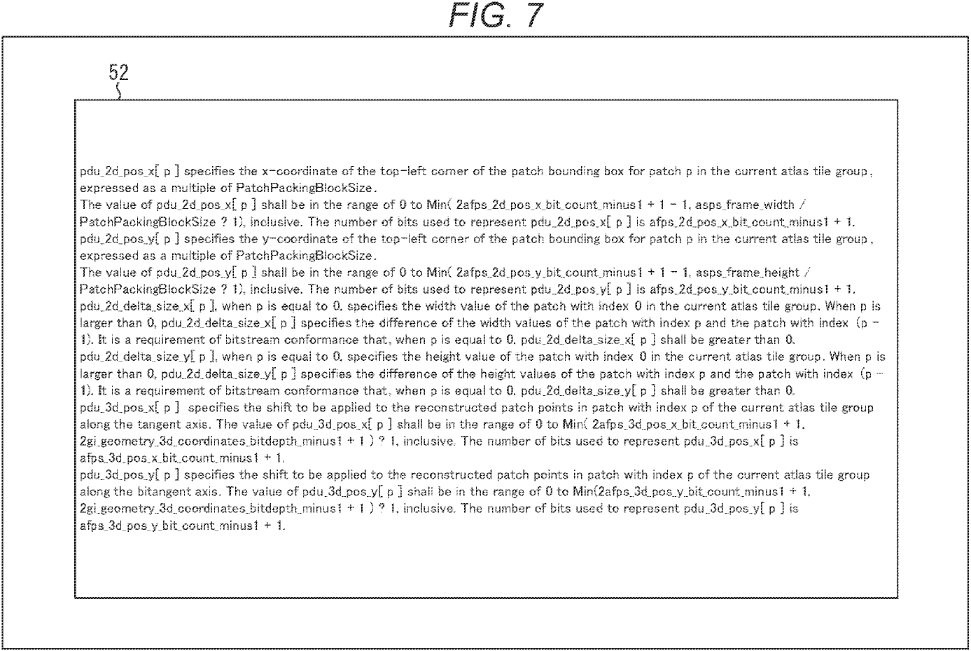

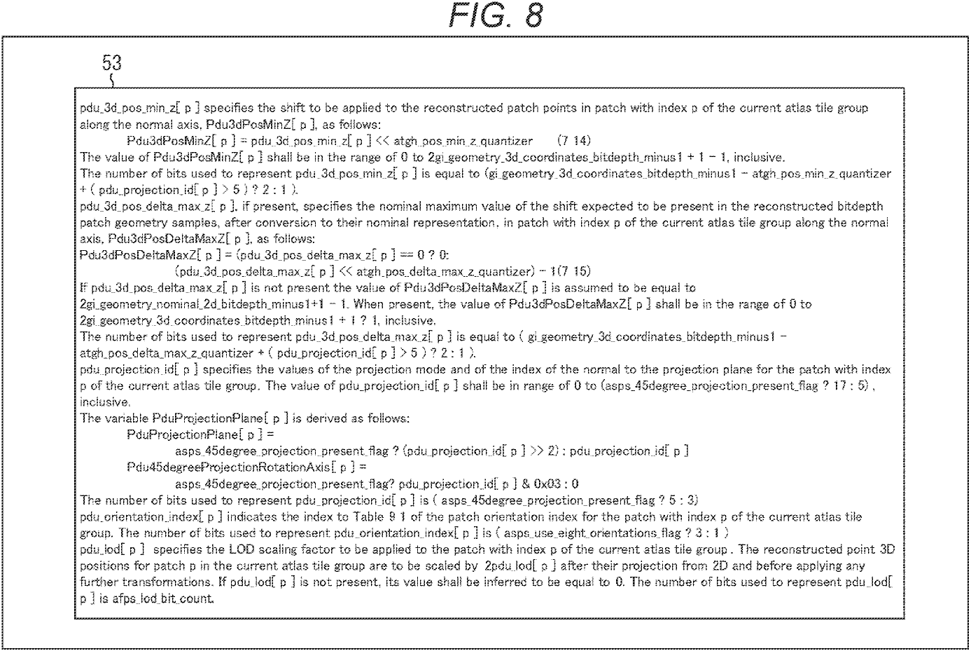

A syntax 51 illustrated in FIG. 6 indicates an example of a syntax of the auxiliary patch information. As disclosed in Non-Patent Document 6, auxiliary patch information includes parameters regarding a position and a size of each patch in a frame, and parameters regarding the generation (projection method, etc.) of each patch as illustrated in FIG. 6, for example. Furthermore, FIGS. 7 and 8 each illustrate an example of semantics of these parameters.

For example, when auxiliary patch information corresponding to a plurality of frames is generated as in “Method 1”, each parameter as illustrated in FIG. 6 is set in such a manner as to correspond to the plurality of frames on the basis of an external setting or information regarding the plurality of frames. Furthermore, for example, when auxiliary patch information applied to a past frame is reused as in “Method 2”, each parameter as illustrated in FIG. 6 is reused in a processing target frame.

Note that any parameters may be included in auxiliary patch information, and the included parameters are not limited to the aforementioned example. For example, camera parameters as described in Non-Patent Document 7 may be included in auxiliary patch information. Non-Patent Document 7 discloses that auxiliary patch information includes, as camera parameters, parameters (matrix) representing mapping (correspondence relationship such as affine transformation, for example) between images including a captured image, an image (projected image) projected on a two-dimensional plane, and an image (viewpoint image) at a viewpoint. That is, in this case, information regarding the position, orientation, and the like of a camera can be included in auxiliary patch information.

### Decoding

Methods from “Method 1” to “Method 3” mentioned above can also be applied to decoding. That is, in decoding, for example, auxiliary patch information can be shared in a section as in “Method 1”, and auxiliary patch information of a previous section can be reused as in “Method 2”.

For example, coded data may be decoded, auxiliary patch information being information regarding a patch obtained by projecting a point cloud representing a three-dimensional shaped object as an aggregate of points, onto a two-dimensional plane for each partial region may be generated, the generated auxiliary patch information may be held, and the point cloud of a plurality of frames may be reconstructed using the held mutually-identical auxiliary patch information.

Furthermore, for example, a point cloud of each frame in a “section” may be reconstructed using held auxiliary patch information corresponding to all of a plurality of frames included in a predetermined section in the time direction of the point cloud. Note that any section may be set as the “section”, and for example, the “section” may be the entire sequence or a GOF.

Moreover, for example, a point cloud of a processing target frame may be reconstructed using held auxiliary patch information corresponding to a past frame being a frame processed in the past.

With this configuration, an increase in load that is caused by decoding coded data of auxiliary patch information can be suppressed. Furthermore, it is sufficient that auxiliary patch information held in a memory (auxiliary patch information applied in the past) is applied, and there is no need to achieve synchronization. Accordingly, it is possible to suppress an increase in load applied when 3D data is reconstructed.

Furthermore, a flag can also be used as in “Method 3”, for example. For example, when a flag acquired from an encoding side indicates that a point cloud of each frame in a “section” is reconstructed using common auxiliary patch information, a point cloud of each frame in the section may be reconstructed using auxiliary patch information corresponding to all frames in the section that is held by an auxiliary patch information holding unit.

Furthermore, for example, when a flag indicates that a point cloud of a processing target frame is generated using auxiliary patch information corresponding to a past frame, a point cloud of a processing target frame may be reconstructed using held auxiliary patch information corresponding to a past frame.

With this configuration, the application of auxiliary patch information can be selected. Accordingly, a broader range of specifications can be supported.

### 2. First Embodiment

### Encoding Device

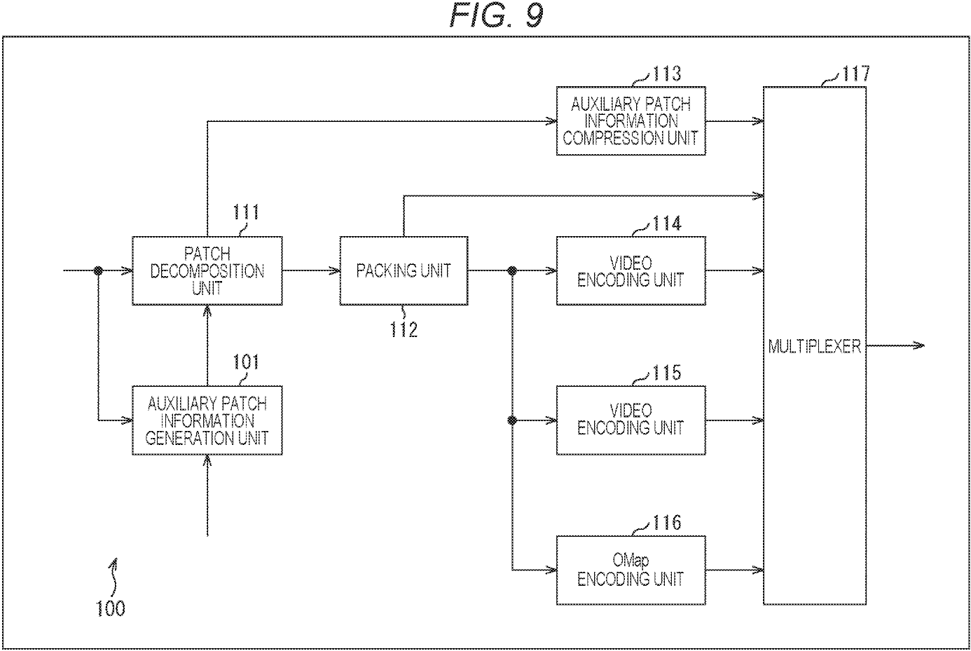

FIG. 9 is a block diagram illustrating an example of a configuration of an encoding device. An encoding device 100 illustrated in FIG. 9 is a device that projects 3D data such as a point cloud onto a two-dimensional plane, and performs encoding using an encoding method for two-dimensional images (encoding device to which video-based approach is applied). The encoding device 100 performs such processing by applying “Method 1” illustrated in the table in FIG. 3.

Note that FIG. 9 illustrates main processing units and main data flows and the like, and processing units and data flows are not limited to those illustrated in FIG. 9. That is, in the encoding device 100, a processing unit not illustrated in FIG. 9 as a block may exist, and processing or a data flow that is not illustrated in FIG. 9 as an arrow or the like may exist.

As illustrated in FIG. 9, the encoding device 100 includes a patch decomposition unit 111, a packing unit 112, an auxiliary patch information compression unit 113, a video encoding unit 114, a video encoding unit 115, an OMap encoding unit 116, and a multiplexer 117.

The patch decomposition unit 111 performs processing related to the decomposition of 3D data. For example, the patch decomposition unit 111 acquires 3D data (for example, point cloud) representing a three-dimensional structure that is input to the encoding device 100. Furthermore, the patch decomposition unit 111 decomposes the acquired 3D data into a plurality of small regions (connection components), projects the 3D data onto a two-dimensional plane for each of the small regions, and generates patches of geometry data and patches of attribute data. That is, the patch decomposition unit 111 decomposes 3D data into patches. In other words, the patch decomposition unit 111 can also be said to be a patch generation unit that generates a patch from 3D data.

The patch decomposition unit 111 supplies each of the generated patches to the packing unit 112. Furthermore, the patch decomposition unit 111 supplies auxiliary patch information used in the generation of the patches, to the packing unit 112 and the auxiliary patch information compression unit 113.

The packing unit 112 performs processing related to the packing of data. For example, the packing unit 112 acquires information regarding patches supplied from the patch decomposition unit 111. Furthermore, the packing unit 112 arranges each of the acquired patches in a two-dimensional image, and packs the patches as a video frame. For example, the packing unit 112 packs patches of geometry data as a video frame, and generates geometry video frame(s). Furthermore, the packing unit 112 packs patches of attribute data as a video frame, and generates color video frame(s). Moreover, the packing unit 112 generates an occupancy map indicating the existence or non-existence of a patch.

The packing unit 112 supplies these to subsequent processing units. For example, the packing unit 112 supplies the geometry video frame to the video encoding unit 114, supplies the color video frame to the video encoding unit 115, and supplies the occupancy map to the OMap encoding unit 116.

The auxiliary patch information compression unit 113 performs processing related to the compression of auxiliary patch information. For example, the auxiliary patch information compression unit 113 acquires auxiliary patch information supplied from the patch decomposition unit 111. The auxiliary patch information compression unit 113 encodes (compresses) the acquired auxiliary patch information using an encoding method other than encoding methods for two-dimensional images. Any method may be used as the encoding method as long as the method is not for two-dimensional images. The auxiliary patch information compression unit 113 supplies obtained coded data of auxiliary patch information to the multiplexer 117.

The video encoding unit 114 performs processing related to the encoding of a geometry video frame. For example, the video encoding unit 114 acquires a geometry video frame supplied from the packing unit 112. Furthermore, the video encoding unit 114 encodes the acquired geometry video frame using an arbitrary encoding method for two-dimensional images such as AVC or HEVC, for example. The video encoding unit 114 supplies coded data of the geometry video frame that has been obtained by the encoding, to the multiplexer 117.

The video encoding unit 115 performs processing related to the encoding of a color video frame. For example, the video encoding unit 115 acquires a color video frame supplied from the packing unit 112. Furthermore, the video encoding unit 115 encodes the acquired color video frame using an arbitrary encoding method for two-dimensional images such as AVC or HEVC, for example. The video encoding unit 115 supplies coded data of the color video frame that has been obtained by the encoding, to the multiplexer 117.

The OMap encoding unit 116 performs processing related to the encoding of a video frame of an occupancy map. For example, the OMap encoding unit 116 acquires an occupancy map supplied from the packing unit 112. Furthermore, the OMap encoding unit 116 encodes the acquired occupancy map using an arbitrary encoding method for two-dimensional images, for example. The OMap encoding unit 116 supplies coded data of the occupancy map that has been obtained by the encoding, to the multiplexer 117.

The multiplexer 117 performs processing related to multiplexing. For example, the multiplexer 117 acquires coded data of auxiliary patch information that is supplied from the auxiliary patch information compression unit 113. Furthermore, for example, the multiplexer 117 acquires coded data of the geometry video frame that is supplied from the video encoding unit 114. Furthermore, for example, the multiplexer 117 acquires coded data of the color video frame that is supplied from the video encoding unit 115. Furthermore, for example, the multiplexer 117 acquires coded data of the occupancy map that is supplied from the OMap encoding unit 116.

The multiplexer 117 generates a bit stream by multiplexing these pieces of acquired information. The multiplexer 117 outputs the generated bit stream to the outside of the encoding device 100.

Furthermore, the encoding device 100 further includes an auxiliary patch information generation unit 101.

The auxiliary patch information generation unit 101 performs processing related to the generation of auxiliary patch information. For example, the auxiliary patch information generation unit 101 can generate auxiliary patch information in such a manner as to correspond to all of a plurality of frames included in a processing target “section”. That is, the auxiliary patch information generation unit 101 can generate auxiliary patch information corresponding to all frames included in a processing target “section”. The “section” is as mentioned above in <1. Auxiliary Patch Information>. For example, the “section” may be the entire sequence, may be a GOF, or may be a data unit other than these.

For example, the auxiliary patch information generation unit 101 can acquire 3D data (for example, point cloud data) input to the encoding device 100, and generate auxiliary patch information corresponding to all frames included in a processing target “section”, on the basis of information regarding each frame in the processing target “section” of the 3D data.

Furthermore, the auxiliary patch information generation unit 101 can acquire setting information (will also be referred to as an external setting) supplied from the outside of the encoding device 100, and generate auxiliary patch information corresponding to all frames included in a processing target “section” on the basis of the external setting.

The auxiliary patch information generation unit 101 supplies the generated auxiliary patch information to the patch decomposition unit 111. The patch decomposition unit 111 generates patches for each frame in a processing target “section” using the supplied auxiliary patch information.

The auxiliary patch information generation unit 101 supplies the generated patches and auxiliary patch information applied in the generation of the patches, to the packing unit 112. Furthermore, the auxiliary patch information generation unit 101 supplies the auxiliary patch information applied in the generation of the patches, to the auxiliary patch information compression unit 113.

The auxiliary patch information compression unit 113 encodes (compresses) auxiliary patch information supplied from the patch decomposition unit 111 (i.e., auxiliary patch information corresponding to all frames included in a processing target “section” that has been generated by the auxiliary patch information generation unit 101, and generates coded data of the auxiliary patch information. The auxiliary patch information compression unit 113 supplies the generated coded data to the multiplexer 117.

With this configuration, the encoding device 100 can share auxiliary patch information among a plurality of frames, and generate patches using the mutually-identical auxiliary patch information. Furthermore, the encoding device 100 can supply auxiliary patch information corresponding to the plurality of frames, to a decoding side. The decoding side can be therefore caused to reconstruct 3D data using the auxiliary patch information corresponding to the plurality of frames. Accordingly, it is possible to suppress an increase in load of decoding.

Note that these processing units (the auxiliary patch information generation unit 101 and processing units from the patch decomposition unit 111 to the multiplexer 117) have arbitrary configurations. For example, each processing unit may include a logic circuit implementing the aforementioned processing. Furthermore, each processing unit may include, for example, a central processing unit (CPU), a read only memory (ROM), a random access memory (RAM), and the like, and implement the aforementioned processing by executing a program using these. As a matter of course, each processing unit may include both of the configurations, and implement a part of the aforementioned processing using a logic circuit and implement the remaining part by executing a program. Configurations of the processing units may be independent of each other. For example, a part of the processing units may implement a part of the aforementioned processing using a logic circuit, another part of the processing units may implement the aforementioned processing by executing programs, and yet another processing unit may implement the aforementioned processing using both of logic circuits and the execution of programs.

### Flow of Encoding Processing

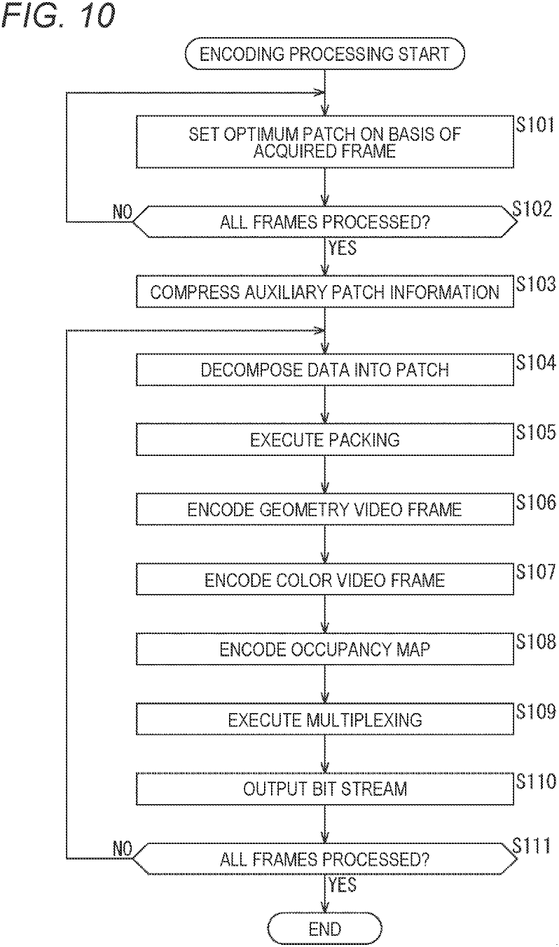

An example of a flow of encoding processing to be executed by the encoding device 100 will be described with reference to a flowchart in FIG. 10. Note that the processing is performed for each of the aforementioned “sections”. That is, each piece of processing illustrated in the flowchart in FIG. 10 is executed on each “section”.

If the encoding processing is started, in Step S101, the auxiliary patch information generation unit 101 of the encoding device 100 performs RD optimization or the like, for example, on the basis of an acquired frame, and generates auxiliary patch information optimum for a processing target “section”.

In Step S102, the auxiliary patch information generation unit 101 determines whether or not all frames in the processing target “section” have been processed. When it is determined that an unprocessed frame exists, the processing returns to Step S101, and the processing in Step S101 and subsequent steps is repeated.

That is, the encoding device 100 executes each piece of processing in Steps S101 to S102 on all frames in the processing target section. If all the frames in the processing target section are processed in this manner, in Step S101, auxiliary patch information optimum for all the frames in the processing target section (i.e., auxiliary patch information corresponding to all frames in the processing target section) is generated.

Then, when it is determined in Step S102 that all frames in the processing target “section” have been processed, the processing proceeds to Step S103.

In Step S103, the auxiliary patch information compression unit 113 compresses the auxiliary patch information obtained by the processing in Step S101. If the processing in Step S103 ends, the processing proceeds to Step S104.

In Step S104, on the basis of the auxiliary patch information generated in Step S101 for the processing target frame, the patch decomposition unit 111 decomposes 3D data (for example, point cloud) into small regions (connection components), projects data of each small region onto a two-dimensional plane (projection surface), and generates patches of geometry data and patches of attribute data.

In Step S105, the packing unit 112 packs the patches generated in Step S104, and generates a geometry video frame and a color video frame. Furthermore, the packing unit 112 generates an occupancy map.

In Step S106, the video encoding unit 114 encodes the geometry video frame obtained by the processing in Step S105, using an encoding method for two-dimensional images. In Step S107, the video encoding unit 115 encodes the color video frame obtained by the processing in Step S105, using an encoding method for two-dimensional images. In Step S108, the OMap encoding unit 116 encodes the occupancy map obtained by the processing in Step S105.

In Step S109, the multiplexer 117 multiplexes various types of information generated as described above, and generates a bit stream including these pieces of information. In Step S110, the multiplexer 117 outputs the bit stream generated by the processing in Step S109, to the outside of the encoding device 100.

In Step S111, the patch decomposition unit 111 determines whether or not all frames in the processing target section have been processed. When an unprocessed frame exists, the processing returns to Step S104. That is, each piece of processing in Steps S104 to S111 is executed on each frame in the processing target section, and a bit stream of each frame is output. When it is determined in Step S111 that all frames in the processing target section have been processed, the encoding processing ends.

By executing each piece of processing in this manner, the encoding device 100 can share auxiliary patch information among a plurality of frames, and generate patches using the mutually-identical auxiliary patch information. The decoding side can be therefore caused to reconstruct 3D data using the auxiliary patch information corresponding to the plurality of frames. Accordingly, it is possible to suppress an increase in load of decoding.

### Flow of Encoding Processing

Auxiliary patch information can also be generated on the basis of an external setting. For example, a user or the like of the encoding device 100 may designate various parameters of auxiliary patch information as illustrated in FIG. 6, and the auxiliary patch information generation unit 101 may generate auxiliary patch information using these parameters.

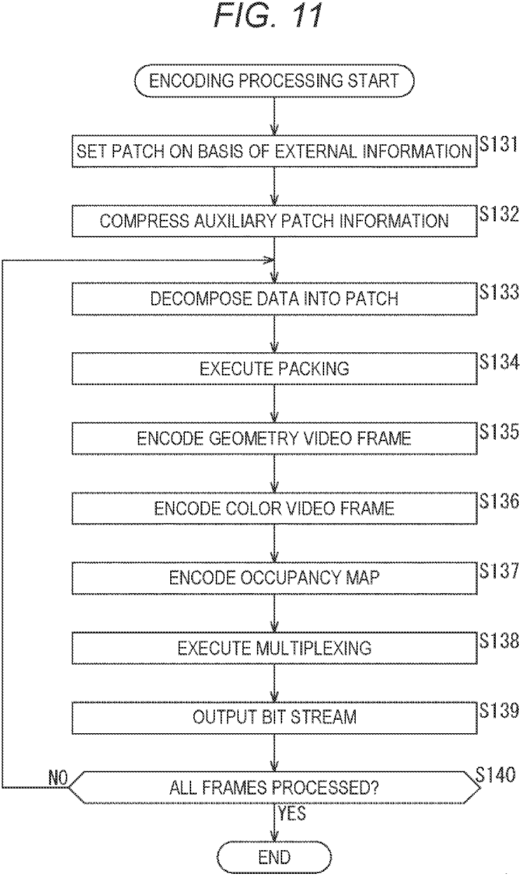

An example of a flow of encoding processing to be executed in this case will be described with reference to a flowchart in FIG. 11. Note that, also in this case, the encoding processing is performed for each of the aforementioned “sections”. That is, each piece of processing illustrated in the flowchart in FIG. 10 is executed on each “section”. In this case, in Step S131, the auxiliary patch information generation unit 101 sets patches on the basis of external information.

Then, in Step S132, the auxiliary patch information compression unit 113 encodes (compresses) the auxiliary patch information generated in Step S131.

Each piece of processing in Steps S133 to S140 is executed similarly to each piece of processing in Steps S104 to S111 of FIG. 10. When it is determined in Step S140 that all frames in the processing target section have been processed, the encoding processing ends.

By executing each piece of processing in this manner, the encoding device 100 can share auxiliary patch information among a plurality of frames, and generate patches using the mutually-identical auxiliary patch information. The decoding side can be therefore caused to reconstruct 3D data using the auxiliary patch information corresponding to the plurality of frames. Accordingly, it is possible to suppress an increase in load of decoding.

### Decoding Device

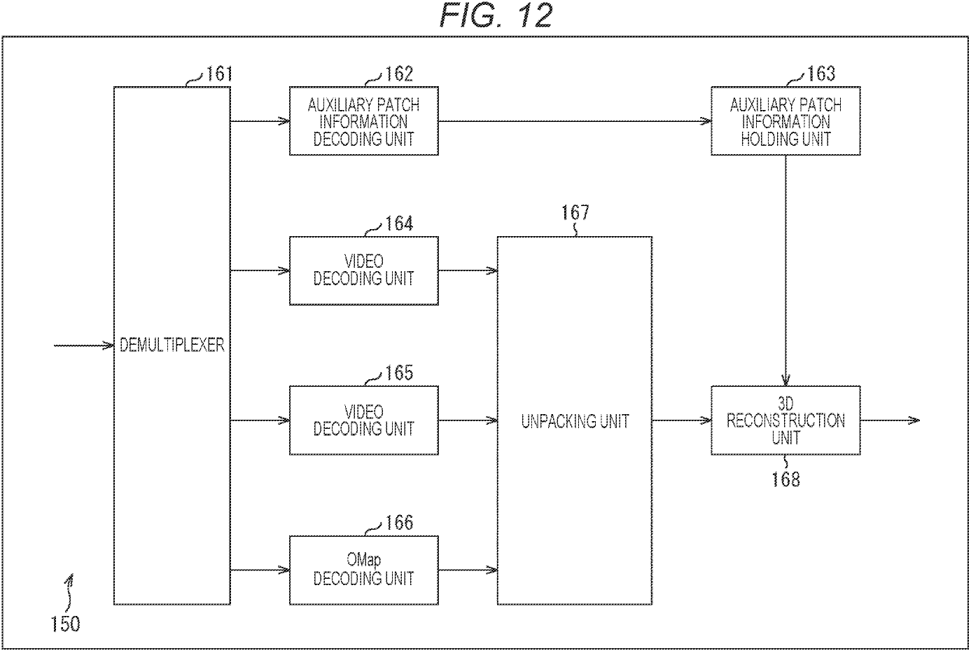

FIG. 12 is a block diagram illustrating an example of a configuration of a decoding device being an aspect of an image processing apparatus to which the present technology is applied. A decoding device 150 illustrated in FIG. 12 is a device that reconstructs 3D data by decoding coded data encoded by projecting 3D data such as a point cloud onto a two-dimensional plane, using a decoding method for two-dimensional images (decoding device to which video-based approach is applied). The decoding device 150 is a decoding device corresponding to the encoding device 100 in FIG. 9, and can reconstruct 3D data by decoding a bit stream generated by the encoding device 100. That is, the decoding device 150 performs such processing by applying “Method 1” illustrated in the table in FIG. 3.

Note that FIG. 12 illustrates main processing units and main data flows and the like, and processing units and data flows are not limited to those illustrated in FIG. 12. That is, in the decoding device 150, a processing unit not illustrated in FIG. 12 as a block may exist, and processing or a data flow that is not illustrated in FIG. 12 as an arrow or the like may exist.

As illustrated in FIG. 12, the decoding device 150 includes a demultiplexer 161, an auxiliary patch information decoding unit 162, an auxiliary patch information holding unit 163, a video decoding unit 164, a video decoding unit 165, an OMap decoding unit 166, an unpacking unit 167, and a 3D reconstruction unit 168.

The demultiplexer 161 performs processing related to the demultiplexing of data. For example, the demultiplexer 161 can acquire a bit stream input to the decoding device 150. The bit stream is supplied by the encoding device 100, for example.

Furthermore, the demultiplexer 161 can demultiplex the bit stream. For example, the demultiplexer 161 can extract coded data of auxiliary patch information from the bit stream by demultiplexing. Furthermore, the demultiplexer 161 can extract coded data of a geometry video frame from the bit stream by demultiplexing. Moreover, the demultiplexer 161 can extract coded data of a color video frame from the bit stream by demultiplexing. Furthermore, the demultiplexer 161 can extract coded data of an occupancy map from the bit stream by demultiplexing.

Moreover, the demultiplexer 161 can supply extracted data to subsequent processing units. For example, the demultiplexer 161 can supply the extracted coded data of the auxiliary patch information to the auxiliary patch information decoding unit 162. Furthermore, the demultiplexer 161 can supply the extracted coded data of the geometry video frame to the video decoding unit 164. Moreover, the demultiplexer 161 can supply the extracted coded data of the color video frame to the video decoding unit 165. Furthermore, the demultiplexer 161 can supply the extracted coded data of the occupancy map to the OMap decoding unit 166.

The auxiliary patch information decoding unit 162 performs processing related to the decoding of coded data of auxiliary patch information. For example, the auxiliary patch information decoding unit 162 can acquire coded data of auxiliary patch information that is supplied from the demultiplexer 161. Furthermore, the auxiliary patch information decoding unit 162 can decode the coded data and generate auxiliary patch information. Any method can be used as the decoding method as long as the method is a method (decoding method not for two-dimensional images) corresponding to an encoding method applied in encoding (for example, encoding method applied by the auxiliary patch information compression unit 113). Moreover, the auxiliary patch information decoding unit 162 supplies the auxiliary patch information to the auxiliary patch information holding unit 163.

The auxiliary patch information holding unit 163 includes a storage medium such as a semiconductor memory, and performs processing related to the holding of auxiliary patch information. For example, the auxiliary patch information holding unit 163 can acquire auxiliary patch information supplied from the auxiliary patch information decoding unit 162. Furthermore, the auxiliary patch information holding unit 163 can hold the acquired auxiliary patch information in the storage medium of itself. Moreover, the auxiliary patch information holding unit 163 can supply held auxiliary patch information to the 3D reconstruction unit 168 as necessary (for example, at a predetermined timing or on the basis of a predetermined request).

The video decoding unit 164 performs processing related to the decoding of coded data of a geometry video frame. For example, the video decoding unit 164 can acquire coded data of a geometry video frame that is supplied from the demultiplexer 161. Furthermore, the video decoding unit 164 can decode the coded data and generate a geometry video frame. Moreover, the video decoding unit 164 can supply the geometry video frame to the unpacking unit 167.

The video decoding unit 165 performs processing related to the decoding of coded data of a color video frame. For example, the video decoding unit 165 can acquire coded data of a color video frame that is supplied from the demultiplexer 161. Furthermore, the video decoding unit 165 can decode the coded data and generate a color video frame. Moreover, the video decoding unit 165 can supply the color video frame to the unpacking unit 167.

The OMap decoding unit 166 performs processing related to the decoding of coded data of an occupancy map. For example, the OMap decoding unit 166 can acquire coded data of an occupancy map that is supplied from the demultiplexer 161. Furthermore, the OMap decoding unit 166 can decode the coded data and generate an occupancy map. Moreover, the OMap decoding unit 166 can supply the occupancy map to the unpacking unit 167.

The unpacking unit 167 performs processing related to unpacking. For example, the unpacking unit 167 can acquire a geometry video frame supplied from the video decoding unit 164. Moreover, the unpacking unit 167 can acquire a color video frame supplied from the video decoding unit 165. Furthermore, the unpacking unit 167 can acquire an occupancy map supplied from the OMap decoding unit 166.

Moreover, the unpacking unit 167 can unpack the geometry video frame and the color video frame on the basis of the acquired occupancy map and the like, and extract patches of geometry data, attribute data, and the like.

Furthermore, the unpacking unit 167 can supply the patches of geometry data, attribute data, and the like to the 3D reconstruction unit 168.

The 3D reconstruction unit 168 performs processing related to the reconstruction of 3D data. For example, the 3D reconstruction unit 168 can acquire auxiliary patch information held in the auxiliary patch information holding unit 163. Furthermore, the 3D reconstruction unit 168 can acquire patches of geometry data and the like that are supplied from the unpacking unit 167. Moreover, the 3D reconstruction unit 168 can acquire patches of attribute data and the like that are supplied from the unpacking unit 167. Furthermore, the 3D reconstruction unit 168 can acquire an occupancy map supplied from the unpacking unit 167. Moreover, the 3D reconstruction unit 168 reconstructs 3D data (for example, point cloud) using these pieces of information.

That is, the 3D reconstruction unit 168 reconstructs 3D data of a plurality of frames using the mutually-identical auxiliary patch information held in the auxiliary patch information holding unit 163. For example, the auxiliary patch information holding unit 163 holds auxiliary patch information corresponding to all frames included in a processing target “section” that is generated by the auxiliary patch information generation unit 101 of the encoding device 100, and supplies the auxiliary patch information to the 3D reconstruction unit 168 in the processing of each frame included in the processing target “section”. The 3D reconstruction unit 168 reconstructs 3D data using the common auxiliary patch information in each frame in the processing target section. Note that, as mentioned above, any section may be set as the “section”, and the “section” may be the entire sequence, may be a GOF, or may be another data unit.

The 3D reconstruction unit 168 outputs 3D data obtained by such processing, to the outside of the decoding device 150. The 3D data is supplied to a display unit and an image thereof is displayed, or the 3D data is recorded onto a recording medium or supplied to another device via communication, for example.

Note that these processing units (processing units from the demultiplexer 161 to the 3D reconstruction unit 168) have arbitrary configurations. For example, each processing unit may include a logic circuit implementing the aforementioned processing. Furthermore, each processing unit may include, for example, a CPU, a ROM, a RAM, and the like, and implement the aforementioned processing by executing a program using these. As a matter of course, each processing unit may include both of the configurations, and implement a part of the aforementioned processing using a logic circuit and implement the remaining part by executing a program. Configurations of the processing units may be independent of each other. For example, a part of the processing units may implement a part of the aforementioned processing using a logic circuit, another part of the processing units may implement the aforementioned processing by executing programs, and yet another processing unit may implement the aforementioned processing using both of logic circuits and the execution of programs.

### Flow of Decoding Processing

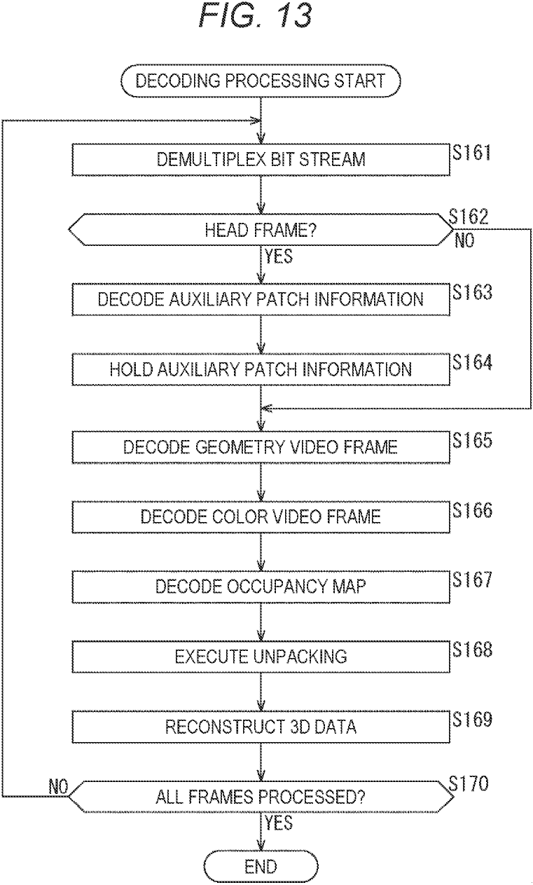

An example of a flow of decoding processing to be executed by such a decoding device 150 will be described with reference to a flowchart in FIG. 13. Note that the processing is performed for each of the aforementioned “sections”. That is, each piece of processing illustrated in the flowchart in FIG. 13 is executed on each “section”.

If the decoding processing is started, in Step S161, the demultiplexer 161 of the decoding device 150 demultiplexes a bit stream.

In Step S162, the demultiplexer 161 determines whether or not a processing target frame is a head frame in a processing target section. When it is determined that a processing target frame is a head frame, the processing proceeds to Step S163.

In Step S163, the auxiliary patch information decoding unit 162 decodes coded data of auxiliary patch information that has been extracted from a bit stream by the processing in Step S161.

In Step S164, the auxiliary patch information holding unit 163 holds the obtained auxiliary patch information decoded in Step S163. If the processing in Step S164 ends, the processing proceeds to Step S165. Furthermore, when it is determined in Step S162 that a processing target frame is not a head frame in a processing target section, the processing in Steps S163 and S164 is omitted, and the processing proceeds to Step S165.

In Step S165, the video decoding unit 164 decodes coded data of a geometry video frame that has been extracted from the bit stream by the processing in Step S161. In Step S166, the video decoding unit 165 decodes coded data of a color video frame that has been extracted from the bit stream by the processing in Step S161. In Step S167, the OMap decoding unit 166 decodes coded data of an occupancy map that has been extracted from the bit stream by the processing in Step S161.

In Step S168, the unpacking unit 167 unpacks the geometry video frame and the color video frame on the basis of the occupancy map and the like.

In Step S169, the 3D reconstruction unit 168 reconstructs 3D data such as a point cloud, for example, on the basis of the auxiliary patch information held in Step S164, and various types of information obtained in Step S168. As mentioned above, only in a head frame in a processing target section, auxiliary patch information is decoded and held. Accordingly, the 3D reconstruction unit 168 reconstructs 3D data of a plurality of frames using the held mutually-identical auxiliary patch information.

In Step S170, the demultiplexer 161 determines whether or not all frames in the processing target section have been processed. When an unprocessed frame exists, the processing returns to Step S161. That is, each piece of processing in Steps S161 to S170 is executed on each frame in the processing target section, and 3D data of each frame is reconstructed. When it is determined in Step S170 that all frames in the processing target section have been processed, the decoding processing ends.

By executing each piece of processing in this manner, the decoding device 150 can share auxiliary patch information among a plurality of frames, and reconstruct 3D data using the mutually-identical auxiliary patch information. For example, using auxiliary patch information corresponding to a plurality of frames (for example, auxiliary patch information corresponding to all frames in a processing target section), the decoding device 150 can reconstruct 3D data of the plurality of frames (for example, each frame in the processing target section). Accordingly, the number of times auxiliary patch information is decoded can be reduced, and an increase in load of decoding can be suppressed. Furthermore, because the 3D reconstruction unit 168 is only required to read out auxiliary patch information held in the auxiliary patch information holding unit 163 and use the read auxiliary patch information for the reconstruction of 3D data, synchronization between geometry data and attribute data, and auxiliary patch information can be achieved more easily.

Note that, in both of a case where the encoding device 100 generates auxiliary patch information on the basis of information regarding each frame in a section, and a case where the encoding device 100 generates auxiliary patch information on the basis of an external setting, the decoding device 150 performs decoding processing as in the flowchart in FIG. 13. That is, the encoding processing may be executed as in the flowchart in FIG. 10, and may be executed as in the flowchart in FIG. 11.

### 3. Second Embodiment

### Encoding Device

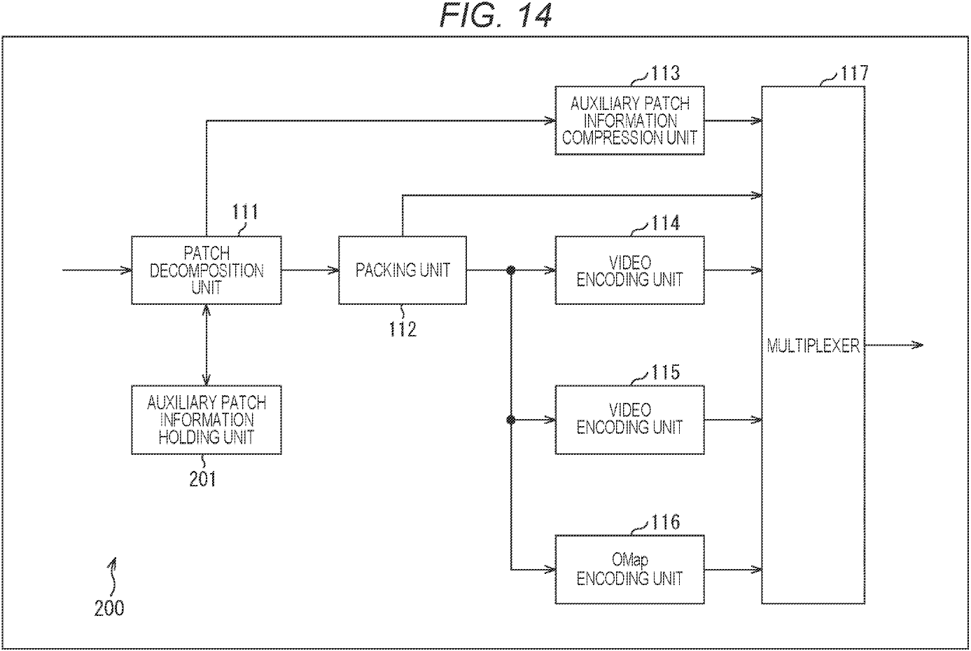

FIG. 14 is a block diagram illustrating an example of a configuration of an encoding device. An encoding device 200 illustrated in FIG. 14 is a device that projects 3D data such as a point cloud onto a two-dimensional plane, and performs encoding using an encoding method for two-dimensional images (encoding device to which video-based approach is applied). The encoding device 200 performs such processing by applying “Method 2” illustrated in the table in FIG. 3.

Note that FIG. 14 illustrates main processing units and main data flows and the like, and processing units and data flows are not limited to those illustrated in FIG. 14. That is, in the encoding device 200, a processing unit not illustrated in FIG. 14 as a block may exist, and processing or a data flow that is not illustrated in FIG. 14 as an arrow or the like may exist.

As illustrated in FIG. 14, the encoding device 200 includes processing units from a patch decomposition unit 111 to a multiplexer 117 similarly to the encoding device 100 (FIG. 9). Nevertheless, the encoding device 200 includes an auxiliary patch information holding unit 201 in place of the auxiliary patch information generation unit 101 of the encoding device 100.

The auxiliary patch information holding unit 201 includes a storage medium such as a semiconductor memory, and performs processing related to the holding of auxiliary patch information. For example, the auxiliary patch information holding unit 201 can acquire auxiliary patch information used in the generation of patches in the patch decomposition unit 111, into a storage medium of itself. Furthermore, the auxiliary patch information holding unit 201 can supply held auxiliary patch information to the patch decomposition unit 111 as necessary (for example, at a predetermined timing or on the basis of a predetermined request).

Note that the number of pieces of auxiliary patch information held by the auxiliary patch information holding unit 201 may be any number. For example, the auxiliary patch information holding unit 201 may be enabled to hold only a single piece of auxiliary patch information (i.e., auxiliary patch information held last (latest auxiliary patch information)), or may be enabled to hold a plurality of pieces of auxiliary patch information.

The patch decomposition unit 111 decomposes 3D data input to the encoding device 200, into a plurality of small regions (connection components), projects the 3D data onto a two-dimensional plane for each of the small regions, and generates patches of geometry data and patches of attribute data. At this time, the patch decomposition unit 111 can generate auxiliary patch information corresponding to a processing target frame, and generate patches using the auxiliary patch information corresponding to the processing target frame. Furthermore, the patch decomposition unit 111 can acquire auxiliary patch information held in the auxiliary patch information holding unit 201 (i.e., auxiliary patch information corresponding to a past frame), and generate patches using the auxiliary patch information corresponding the past frame.

For example, for a head frame in a processing target section, the patch decomposition unit 111 generates auxiliary patch information and generates patches using the auxiliary patch information, and for frames other than the head frame, acquires auxiliary patch information used in the generation of patches in the immediately preceding frame, from the auxiliary patch information holding unit 201, and generates patches using the acquired auxiliary patch information.

As a matter of course, this is an example, and a configuration is not limited to the example. For example, the patch decomposition unit 111 may generate auxiliary patch information corresponding to a processing target frame, in a frame other than a head frame in the processing target section. Furthermore, the patch decomposition unit 111 may acquire auxiliary patch information used in the generation of patches in a frame processed two or more frames ago, from the auxiliary patch information holding unit 201. Note that any section may be set as the “section”, and the “section” may be the entire sequence, may be a GOF, or may be another data unit, for example.

Note that, as mentioned above, the patch decomposition unit 111 can supply auxiliary patch information used in the generation of patches, to the auxiliary patch information holding unit 201, and hold the auxiliary patch information into the auxiliary patch information holding unit 201. By the processing, auxiliary patch information held in the auxiliary patch information holding unit 201 is updated (overwritten or added). Note that, when the patch decomposition unit 111 generates patches using auxiliary patch information acquired from the auxiliary patch information holding unit 201, the update of the auxiliary patch information holding unit 201 may be omitted. That is, only when the patch decomposition unit 111 has generated auxiliary patch information, the patch decomposition unit 111 may supply the auxiliary patch information to the auxiliary patch information holding unit 201.

When the patch decomposition unit 111 has generated auxiliary patch information, the patch decomposition unit 111 supplies the auxiliary patch information to the auxiliary patch information compression unit 113, and causes the auxiliary patch information compression unit 113 to generate coded data by encoding (compressing) the auxiliary patch information. Furthermore, the patch decomposition unit 111 supplies the generated patches of geometry data and attribute data to the packing unit 112 together with the used auxiliary patch information.

The processing units from the packing unit 112 to the multiplexer 117 perform processing similar to those of the encoding device 100. For example, the video encoding unit 114 encodes a geometry video frame and generates coded data of the geometry video frame. Furthermore, for example, the video encoding unit 114 encodes a color video frame and generates coded data of the color video frame.

With this configuration, the encoding device 200 can generate patches by reusing auxiliary patch information corresponding to a past frame, in a processing target frame. That is, the encoding device 200 can share auxiliary patch information among a plurality of frames, and generate patches using the mutually-identical auxiliary patch information. The decoding side can also be therefore caused to reconstruct 3D data by reusing auxiliary patch information corresponding to a past frame, in a processing target frame. Accordingly, it is possible to suppress an increase in load of decoding.

### Flow of Encoding Processing

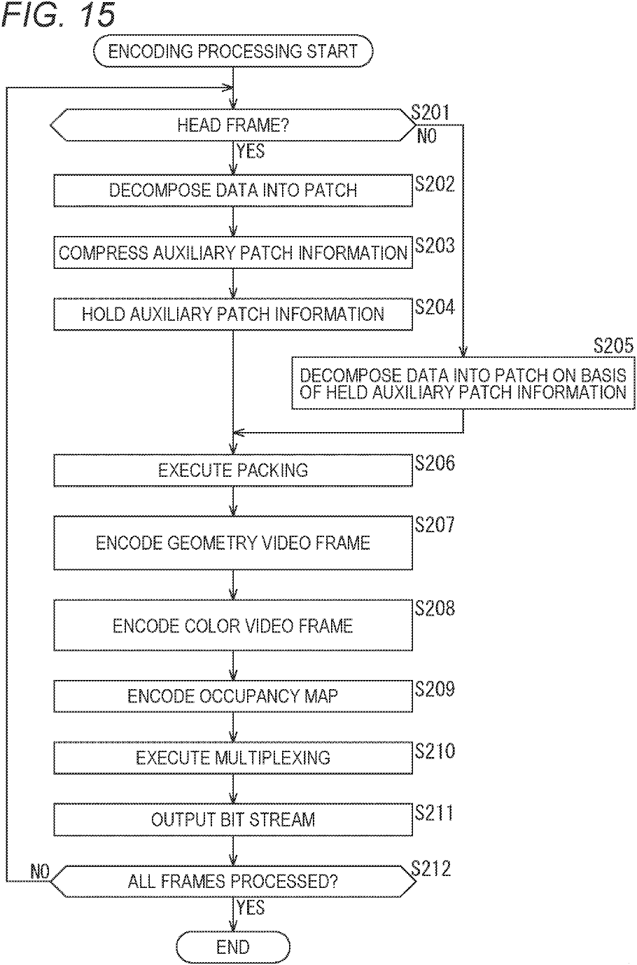

An example of a flow of encoding processing to be executed by such an encoding device 200 will be described with reference to a flowchart in FIG. 15. Note that the processing is performed for each of the aforementioned “sections”. That is, each piece of processing illustrated in the flowchart in FIG. 15 is executed on each “section”.

If the encoding processing is started, in Step S201, the patch decomposition unit 111 determines whether or not a processing target frame is a head frame in a processing target section. When it is determined that a processing target frame is a head frame, the processing proceeds to Step S202.

In the case of a head frame, in Step S202, the patch decomposition unit 111 generates auxiliary patch information corresponding to the processing target frame, and decomposes input 3D data into patches using the auxiliary patch information. That is, the patch decomposition unit 111 generates patches. Note that any generation method may be used as a generation method of auxiliary patch information in this case. For example, auxiliary patch information may be generated on the basis of an external setting, or auxiliary patch information may be generated on the basis of 3D data.

In Step S203, the auxiliary patch information compression unit 113 encodes (compresses) the generated auxiliary patch information and generates coded data of the auxiliary patch information.

In Step S204, the auxiliary patch information holding unit 201 holds the generated auxiliary patch information. If the processing in Step S204 ends, the processing proceeds to Step S206. Furthermore, when it is determined in Step S201 that a processing target frame is not a head frame in a processing target section, the processing proceeds to Step S205.

In Step S205, the patch decomposition unit 111 acquires auxiliary patch information held in the auxiliary patch information holding unit 201 (that is, auxiliary patch information corresponding to a past frame), and generates patches of the processing target frame using the auxiliary patch information. If the processing in Step S205 ends, the processing proceeds to Step S206.

Each piece of processing in Steps S206 to 5211 is executed similarly to each piece of processing in Steps S105 to S110 of FIG. 10.

In Step S212, the patch decomposition unit 111 determines whether or not all frames in the processing target section have been processed. When an unprocessed frame exists, the processing returns to Step S201. That is, each piece of processing in Steps S201 to S212 is executed on each frame in the processing target section, and a bit stream of each frame is output. When it is determined in Step S212 that all frames in the processing target section have been processed, the encoding processing ends.

By executing each piece of processing in this manner, the encoding device 200 can generate patches by reusing auxiliary patch information corresponding to a past frame, in a processing target frame. That is, the encoding device 200 can share auxiliary patch information among a plurality of frames, and generate patches using the mutually-identical auxiliary patch information. The decoding side can also be therefore caused to reconstruct 3D data by reusing auxiliary patch information corresponding to a past frame, in a processing target frame. Accordingly, it is possible to suppress an increase in load of decoding.

### Decoding Side

The decoding device 150 illustrated in FIG. 12 corresponds also to such an encoding device 200. That is, for a head frame, the decoding device 150 generates auxiliary patch information corresponding to a processing target frame, by decoding coded data, and holds the auxiliary patch information into the auxiliary patch information holding unit 163. Furthermore, for frames other than the head frame, the decoding device 150 omits the decoding of coded data of auxiliary patch information. The 3D reconstruction unit 168 reconstructs 3D data using auxiliary patch information corresponding to a past frame that is held in the auxiliary patch information holding unit 163.

With this configuration, for a head frame, the 3D reconstruction unit 168 can reconstruct 3D data using auxiliary patch information corresponding to a processing target frame, and for frames other than the head frame, the 3D reconstruction unit 168 can reconstruct 3D data using auxiliary patch information corresponding to a past frame. Accordingly, it is possible to suppress an increase in load.

Note that, because the decoding processing can be performed by a flow similar to that of the flowchart in FIG. 13, for example, the description will be omitted.

### 4. Third Embodiment

### Encoding Device

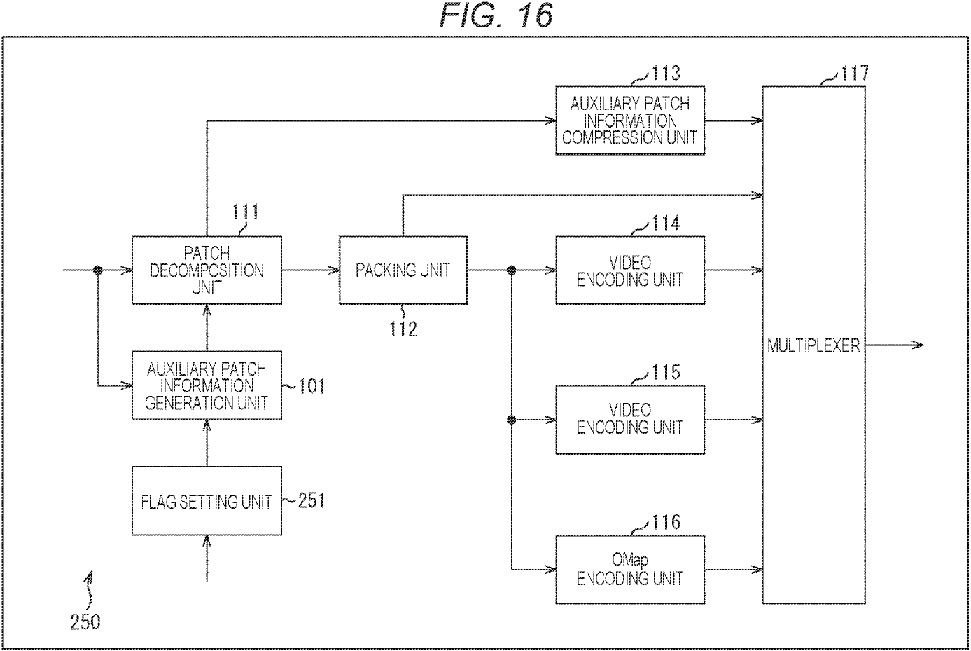

FIG. 16 is a block diagram illustrating an example of a configuration of an encoding device. An encoding device 250 illustrated in FIG. 16 is a device that projects 3D data such as a point cloud onto a two-dimensional plane, and performs encoding using an encoding method for two-dimensional images (encoding device to which video-based approach is applied). The encoding device 250 performs such processing by applying “Method 3-1” illustrated in the table in FIG. 3.

Note that FIG. 16 illustrates main processing units and main data flows and the like, and processing units and data flows are not limited to those illustrated in FIG. 16. That is, in the encoding device 250, a processing unit not illustrated in FIG. 16 as a block may exist, and processing or a data flow that is not illustrated in FIG. 16 as an arrow or the like may exist.

As illustrated in FIG. 16, the encoding device 250 includes a flag setting unit 251 aside from the configurations of the encoding device 100 (FIG. 9).

The flag setting unit 251 sets a flag (will also be referred to as an intra-section share flag) indicating whether to generate patches of each frame in a processing target section using common auxiliary patch information. Any setting method may be used as the setting method. For example, the flag may be set on the basis of an instruction from the outside of the encoding device 250 that is issued by a user or the like. Furthermore, the flag may be predefined. Moreover, the flag may be set on the basis of 3D data input to the encoding device 250.

The auxiliary patch information generation unit 101 generates auxiliary patch information (common auxiliary patch information) corresponding to all frames included in a processing target section, on the basis of the flag information set by the flag setting unit 251.

For example, when an intra-section share flag set by the flag setting unit 251 indicates that patches of each frame in the processing target section are generated using common auxiliary patch information, the auxiliary patch information generation unit 101 may generate common auxiliary patch information in such a manner as to correspond to all frames included in the processing target section, and the patch decomposition unit 111 may generate patches using the generated common auxiliary patch information for each frame in the processing target section.

Furthermore, for example, when an intra-section share flag set by the flag setting unit indicates that patches of each frame in the processing target section are generated using auxiliary patch information of a corresponding frame, the auxiliary patch information generation unit 101 may generate auxiliary patch information for each of the frames included in the processing target section, and the patch decomposition unit 111 may generate, for each of the frames included in the section, patches using auxiliary patch information corresponding to the target frame that has been generated by the auxiliary patch information generation unit 101.

With this configuration, a generation method of auxiliary patch information can be selected. Accordingly, a broader range of specifications can be supported.

### Flow of Encoding Processing

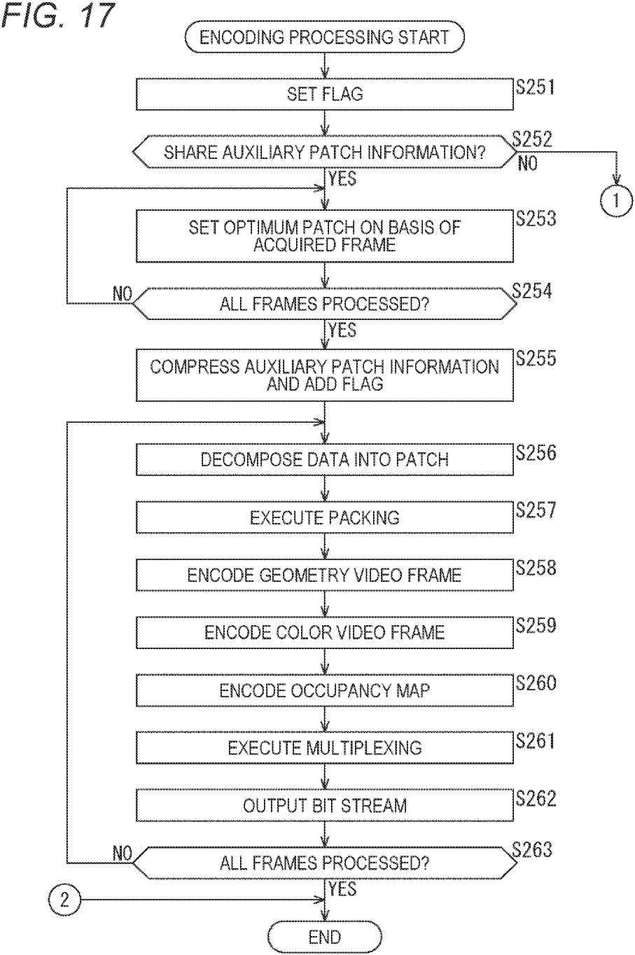

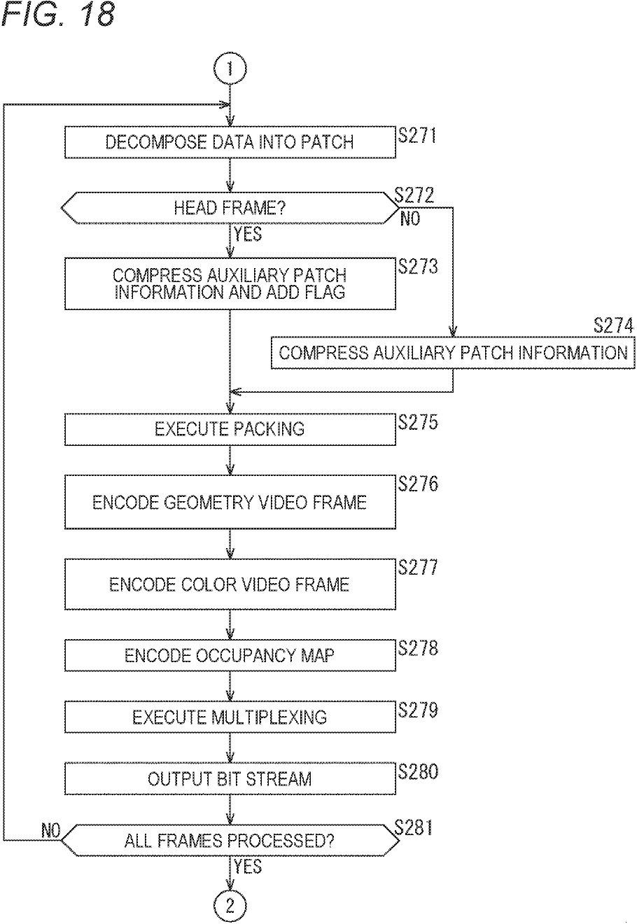

An example of a flow of encoding processing to be executed by the encoding device 250 in this case will be described with reference to flowcharts in FIGS. 17 and 18.

In this case, if the encoding processing is started, in Step S251, the flag setting unit 251 of the encoding device 250 sets a flag (intra-section share flag).

In Step S252, the auxiliary patch information generation unit 101 determines whether or not to supply auxiliary patch information, on the basis of the intra-section share flag set in Step S251. When the intra-section share flag is true (for example, 1), and it is determined that auxiliary patch information is shared among a plurality of frames, the processing proceeds to Step S253.

In this case, each piece of processing in Steps S253 to S263 is executed similarly to each piece of processing in Steps S101 to S111. When it is determined in Step S263 that all frames in the processing target section have been processed, the encoding processing ends.

Furthermore, when it is determined in Step S252 that auxiliary patch information is not shared among a plurality of frames, the processing proceeds to Step S271 of FIG. 18. In this case, auxiliary patch information is generated for each frame.

In Step S271 of FIG. 18, the patch decomposition unit 111 generates auxiliary patch information, generates patches on the basis of the auxiliary patch information, and decomposes 3D data into patches.

In Step S272, the auxiliary patch information compression unit 113 determines whether or not a processing target frame is a head frame in a processing target section. When it is determined that a processing target frame is a head frame, the processing proceeds to Step S273.

In Step S273, the auxiliary patch information compression unit 113 encodes (compresses) the auxiliary patch information, and moreover, adds an intra-section share flag to coded data of the auxiliary patch information. If the processing in Step S273 ends, the processing proceeds to Step S275.

Furthermore, when it is determined in Step S272 that a processing target frame is not a head frame, the processing proceeds to Step S274. In Step S274, the auxiliary patch information compression unit 113 encodes (compresses) auxiliary patch information. If the processing in Step S274 ends, the processing proceeds to Step S275.

Each piece of processing in Steps S275 to S280 is executed similarly to each piece of processing in Steps S105 to S110 (FIG. 10). In Step S281, the patch decomposition unit 111 determines whether or not all frames in the processing target section have been processed. When an unprocessed frame exists, the processing returns to Step S271. That is, each piece of processing in Steps S271 to S281 is executed on each frame in the processing target section, and a bit stream of each frame is output. When it is determined in Step S281 that all frames in the processing target section have been processed, the encoding processing ends.

By executing each piece of processing in this manner, the encoding device 250 can select a generation method of auxiliary patch information. Accordingly, a broader range of specifications can be supported.

### Flow of Decoding Processing

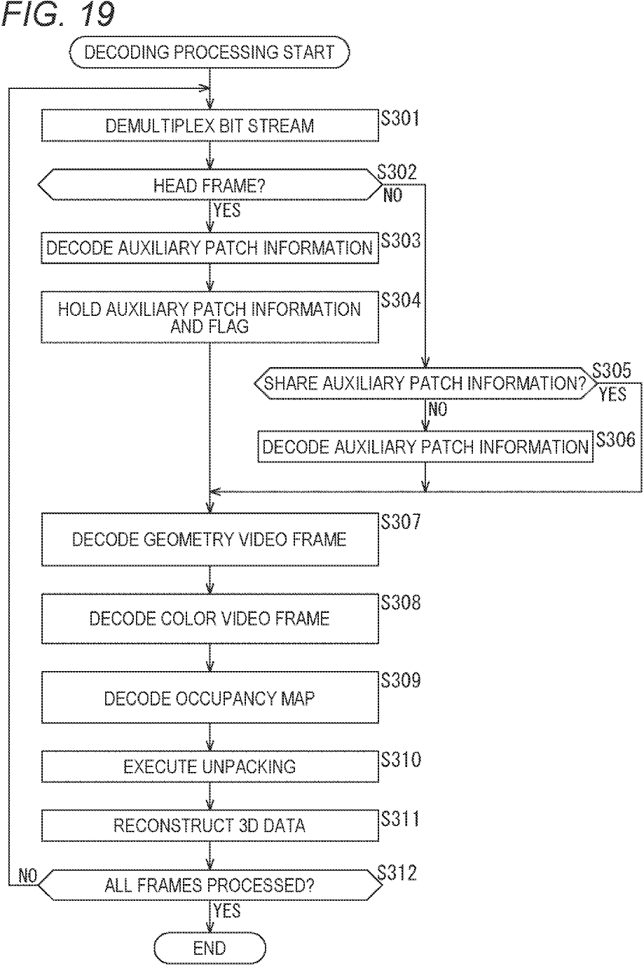

The decoding device 150 illustrated in FIG. 12 corresponds also to such an encoding device 250. Accordingly, the description will be omitted. FIG. 19 is a flowchart describing an example of a flow of decoding processing to be executed by the decoding device 150 in this case.

Also in this case, each piece of processing in Steps S301 to S303 is executed similarly to each piece of processing in Steps S161 to S163 (FIG. 13).

Nevertheless, in Step S304, the auxiliary patch information holding unit 163 also holds the aforementioned intra-section share flag in addition to auxiliary patch information.

Furthermore, when it is determined in Step S302 that a processing target frame is not a head frame, in Step S305, the auxiliary patch information decoding unit 162 determines whether or not to share auxiliary patch information among a plurality of frames. When it is determined that auxiliary patch information is not shared, in Step S306, the auxiliary patch information decoding unit 162 decodes coded data and generates auxiliary patch information. If auxiliary patch information is generated, the processing proceeds to Step S307. Furthermore, when it is determined in Step S305 that auxiliary patch information is shared, the processing proceeds to Step S307.

Each piece of processing in Steps S307 to S311 is executed similarly to each piece of processing in Steps S165 to S119. In Step S312, the demultiplexer 161 determines whether or not all frames in the processing target section have been processed. When an unprocessed frame exists, the processing returns to Step S301. That is, each piece of processing in Steps S301 to S312 is executed on each frame in the processing target section, and 3D data of each frame is output. When it is determined in Step S312 that all frames in the processing target section have been processed, the decoding processing ends.

### 5. Fourth Embodiment

### Encoding Device

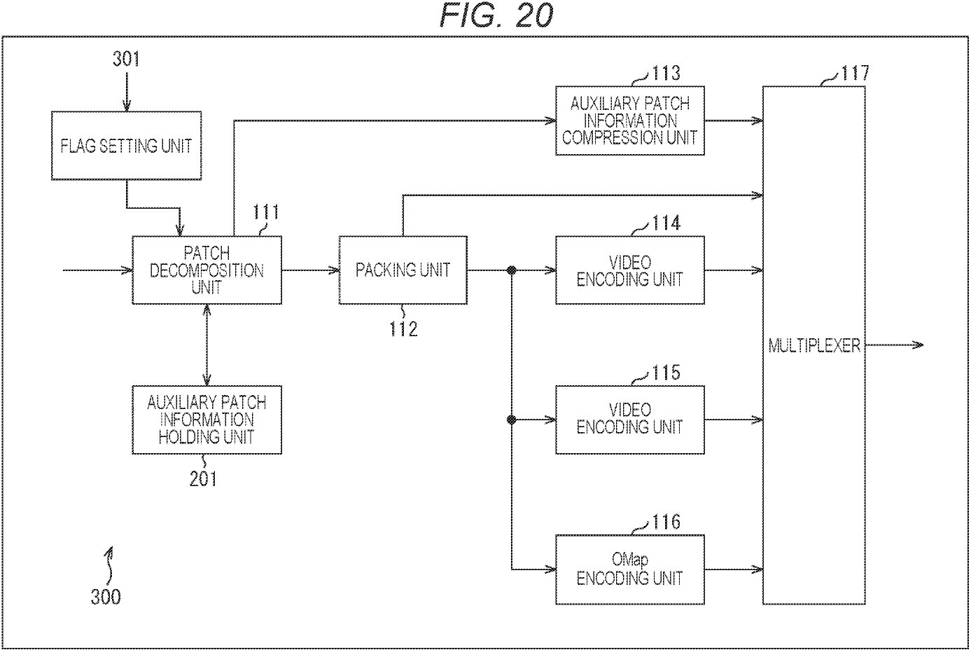

FIG. 20 is a block diagram illustrating an example of a configuration of an encoding device. An encoding device 300 illustrated in FIG. 20 is a device that projects 3D data such as a point cloud onto a two-dimensional plane, and performs encoding using an encoding method for two-dimensional images (encoding device to which video-based approach is applied). The encoding device 300 performs such processing by applying “Method 3-2” illustrated in the table in FIG. 3.

Note that FIG. 20 illustrates main processing units and main data flows and the like, and processing units and data flows are not limited to those illustrated in FIG. 20. That is, in the encoding device 300, a processing unit not illustrated in FIG. 20 as a block may exist, and processing or a data flow that is not illustrated in FIG. 20 as an arrow or the like may exist.

As illustrated in FIG. 20, the encoding device 300 includes a flag setting unit 301 aside from the configurations of the encoding device 200 (FIG. 14).

The flag setting unit 301 sets a flag (will also be referred to as a reuse flag) indicating whether to generate patches of a processing target frame using auxiliary patch information corresponding to a past frame. Any setting method may be used as the setting method. For example, the flag may be set on the basis of an instruction from the outside of the encoding device 300 that is issued by a user or the like. Furthermore, the flag may be predefined. Moreover, the flag may be set on the basis of 3D data input to the encoding device 300.

On the basis of the flag information set by the flag setting unit 301, the patch decomposition unit 111 generates patches of a processing target frame using auxiliary patch information corresponding to a past frame that is held in the auxiliary patch information holding unit 201.

For example, when a reuse flag set by the flag setting unit 301 indicates that patches of a processing target frame are generated using auxiliary patch information corresponding to a past frame, the patch decomposition unit 111 may generate patches of a processing target frame using auxiliary patch information corresponding to a past frame that is held in the auxiliary patch information holding unit 201.

Furthermore, for example, when a reuse flag set by the flag setting unit 301 indicates that patches of a processing target frame are not generated using auxiliary patch information corresponding to a past frame, the patch decomposition unit 111 may generate auxiliary patch information corresponding to the processing target frame, and generate patches of the processing target frame using the generated auxiliary patch information.

With this configuration, a generation method of auxiliary patch information can be selected. Accordingly, a broader range of specifications can be supported.

### Flow of Encoding Processing

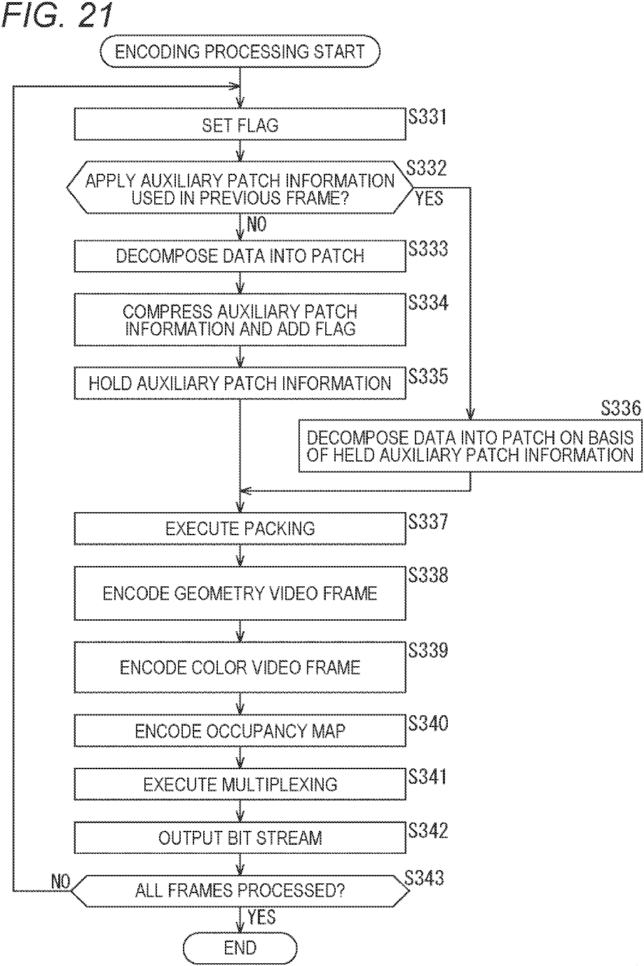

An example of a flow of encoding processing to be executed by the encoding device 300 in this case will be described with reference to a flowchart in FIG. 21.

In this case, if the encoding processing is started, in Step S331, the flag setting unit 301 of the encoding device 250 sets a flag (reuse flag).

In Step S332, on the basis of the reuse flag set in Step S331, the patch decomposition unit 111 determines whether or not to apply auxiliary patch information used in a previous frame, to a processing target frame. When the reuse flag is false (for example, 0), and it is determined that auxiliary patch information used in a previous frame is not reused, the processing proceeds to Step S333.

In Step S333, the patch decomposition unit 111 generates auxiliary patch information corresponding to the processing target frame, generates patches on the basis of the auxiliary patch information, and decomposes 3D data into patches. In Step S334, the auxiliary patch information compression unit 113 encodes (compresses) the auxiliary patch information, and moreover, adds the reuse flag to coded data of the auxiliary patch information.

In Step S335, the auxiliary patch information holding unit 201 holds the auxiliary patch information generated in Step S333. If the processing in Step S335 ends, the processing proceeds to Step S337.

Furthermore, when it is determined in Step S332 that auxiliary patch information used in the previous frame is reused, the processing proceeds to Step S336. In Step S336, the patch decomposition unit 111 reads out auxiliary patch information held in the auxiliary patch information holding unit 201, generates patches on the basis of the read auxiliary patch information, and decomposes 3D data into patches. If the processing in Step S336 ends, the processing proceeds to Step S337.

In Steps S337 to S342, processing basically similar to each piece of processing in Steps S206 to S211 (FIG. 15) is executed. In Step S343, the patch decomposition unit 111 determines whether or not all frames in the processing target section have been processed. When an unprocessed frame exists, the processing returns to Step S331. That is, each piece of processing in Steps S331 to S343 is executed on each frame in the processing target section, and a bit stream of each frame is output. When it is determined in Step S343 that all frames in the processing target section have been processed, the encoding processing ends.

### Flow of Decoding Processing

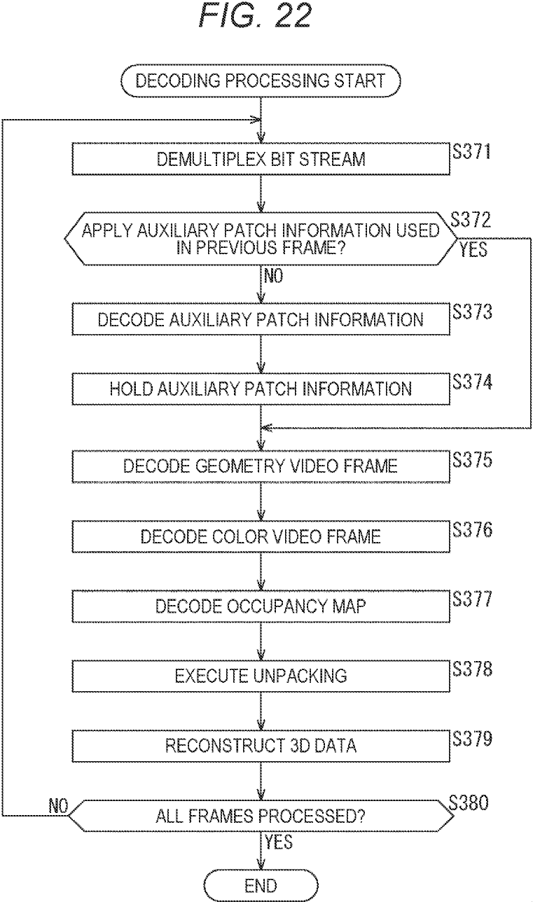

The decoding device 150 illustrated in FIG. 12 corresponds also to such an encoding device 300. Accordingly, the description will be omitted. FIG. 22 is a flowchart describing an example of a flow of decoding processing to be executed by the decoding device 150 in this case.

If the decoding processing is started, in Step S371, the demultiplexer 161 of the decoding device 150 demultiplexes a bit stream.

In Step S372, on the basis of a reuse flag, the demultiplexer 161 determines whether or not to apply auxiliary patch information used in a past frame, to a processing target frame. When it is determined that auxiliary patch information used in a past frame is not applied to a processing target frame, the processing proceeds to Step S373. Furthermore, when it is determined that auxiliary patch information used in a past frame is applied to a processing target frame, the processing proceeds to Step S375.

Each piece of processing in Steps S373 to S380 is executed similarly to each piece of processing in Steps S163 to S170.

When each piece of processing in Steps S371 to S380 is executed on each frame, and it is determined in Step S380 that all frames have been processed, the decoding processing ends.

### 6. Fifth Embodiment

### System Example 1 to Which Present Technology Is Applied

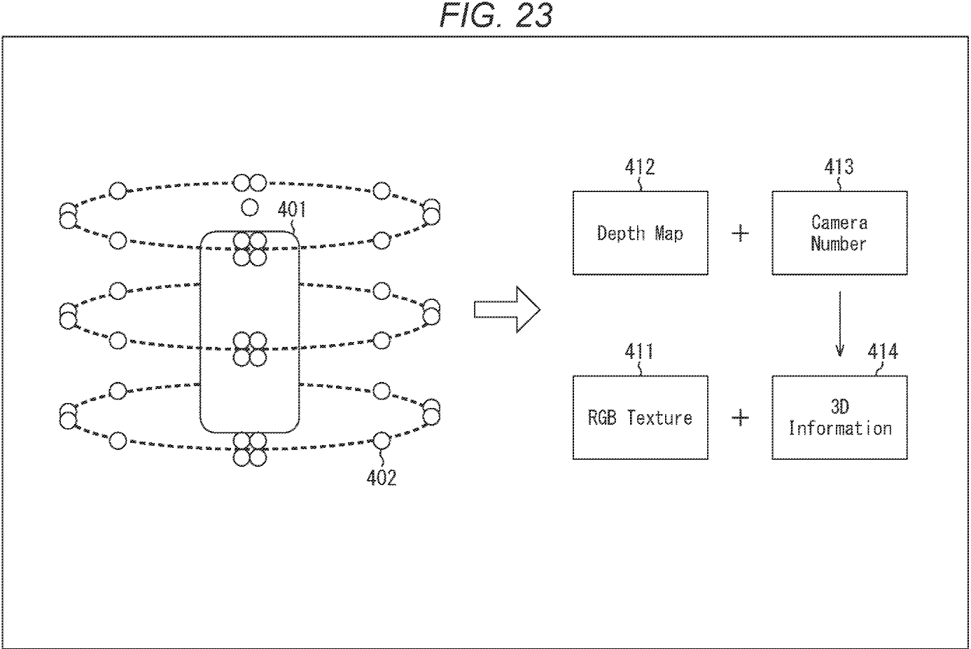

As illustrated on the left side in FIG. 23, for example, the present technology described above can be applied to a system that captures images of a subject 401 using a plurality of stationary cameras 402, and generates 3D data of the subject 401 from the captured images.

In the case of such a system, as illustrated on the right side in FIG. 23, for example, a depth map 412 is generated using captured images and the like of the plurality of stationary cameras 402, and three-dimensional information (3D Information) 414 is generated from identification information 413 of each stationary camera. A captured image 411 of each camera is used a texture (attribute data), and is transmitted together with the three-dimensional information 414. That is, information similar to video-based approach of a point cloud is transmitted.

Then, because the captured images of the stationary cameras 402 with a fixed angle, and the depth map correspond to patches of geometry data and attribute data in the video-based approach, the configuration of each patch does not vary largely. Therefore, by applying the present technology mentioned above, patch information can be shared among a plurality of frames. Then, by applying the present technology, an increase in load of decoding of a point cloud can be suppressed.

Furthermore, in this case, each patch can be represented using camera parameters indicating the position, the orientation, and the like of each stationary camera 402. For example, as in the example of Non-Patent Document 7, a parameter (for example, matrix) indicating mapping between images such as a captured image, a projected image, and a viewpoint image may be included in auxiliary patch information. With this configuration, each patch can be efficiently represented.

### 7. Sixth Embodiment

### System Example 2 to Which Present Technology Is Applied

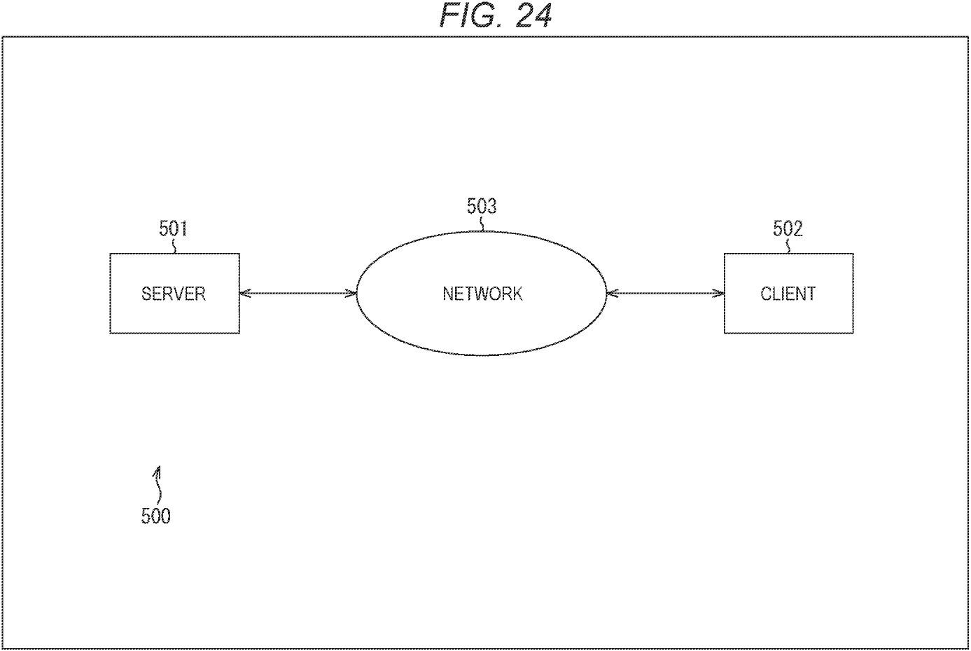

Furthermore, the present technology can also be applied to an image processing system 500 including a server 501 and a client 502 that transmit and receive 3D data, as illustrated in FIG. 24, for example. In the image processing system 500, the server 501 and the client 502 are connected via an arbitrary network 503 in such a manner that communication can be performed with each other. For example, 3D data can be transmitted from the server 501 to the client 502.

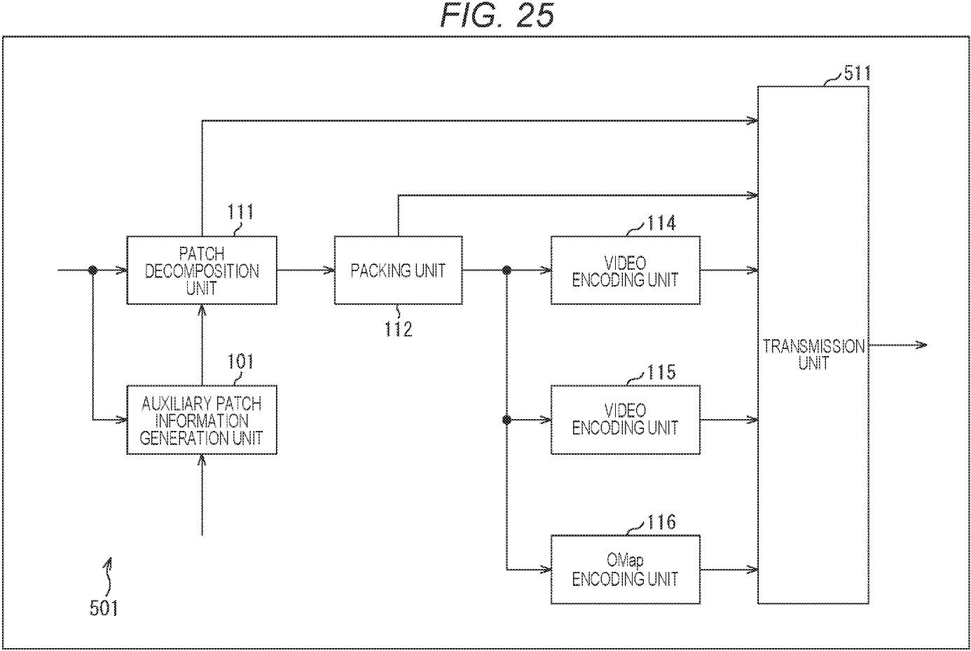

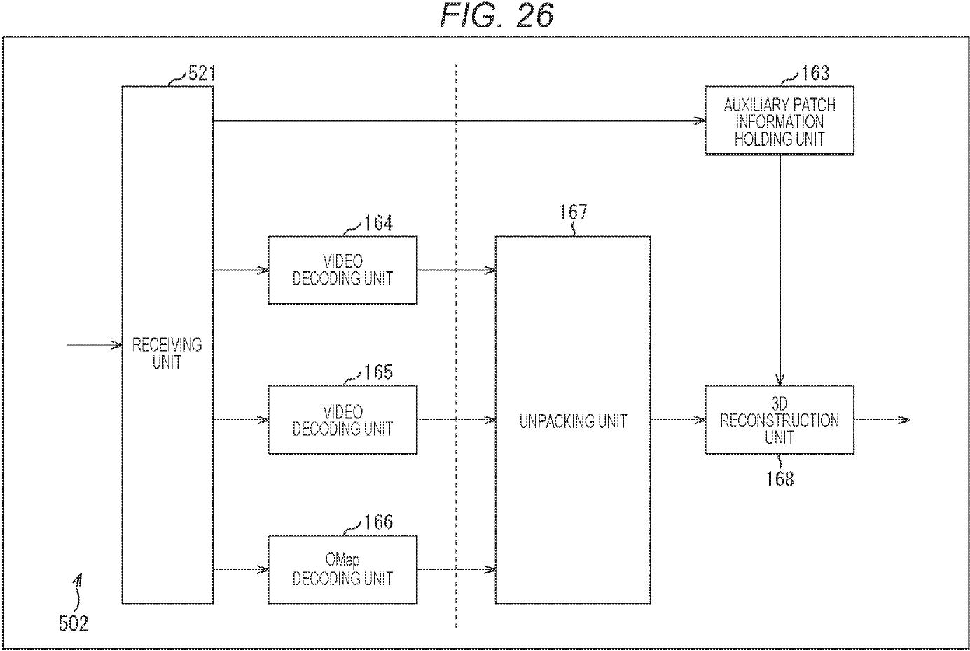

By applying the present technology to such an image processing system 500, 2D image data can be transmitted and received. For example, a configuration as illustrated in FIG. 25 can be employed as the configuration of the server 501, and a configuration as illustrated in FIG. 26 can be employed as the configuration of the client 502.

That is, the server 501 can include an auxiliary patch information generation unit 101, a patch decomposition unit 111, a packing unit 112, processing units from a video encoding unit 114 to an OMap encoding unit 116, and a transmission unit 511, and the client 502 can include a receiving unit 521 and processing units from an auxiliary patch information holding unit 163 to a 3D reconstruction unit 168.

The transmission unit 511 of the server 501 transmits auxiliary patch information supplied from the patch decomposition unit 111, and coded data of video frames respectively supplied from encoding units from the video encoding unit 114 to the OMap encoding unit 116, to the client.

The receiving unit 521 of the client 502 receives these pieces of data. Auxiliary patch information can be held in the auxiliary patch information holding unit 163. A geometry video frame can be decoded by the video decoding unit 164. A color video frame can be decoded by the video decoding unit 165. Then, an occupancy map can be decoded by the OMap decoding unit 166.

That is, in this case, because there is no need to execute multiplexing using a multiplexer or execute demultiplexing using a demultiplexer when data is transmitted and received, the client 502 can decode data supplied from the server 501, using an existing decoder for two-dimensional images, without using a decoder for video-based approach. Although configurations for 3D data reconstruction that are provided on the right side of a dotted line in FIG. 26 are required, these configurations can be treated as subsequent processing. Accordingly, it is possible to suppress an increase in load of data transmission and reception between the server 501 and the client 502.

### Flow of Data Transmission Processing

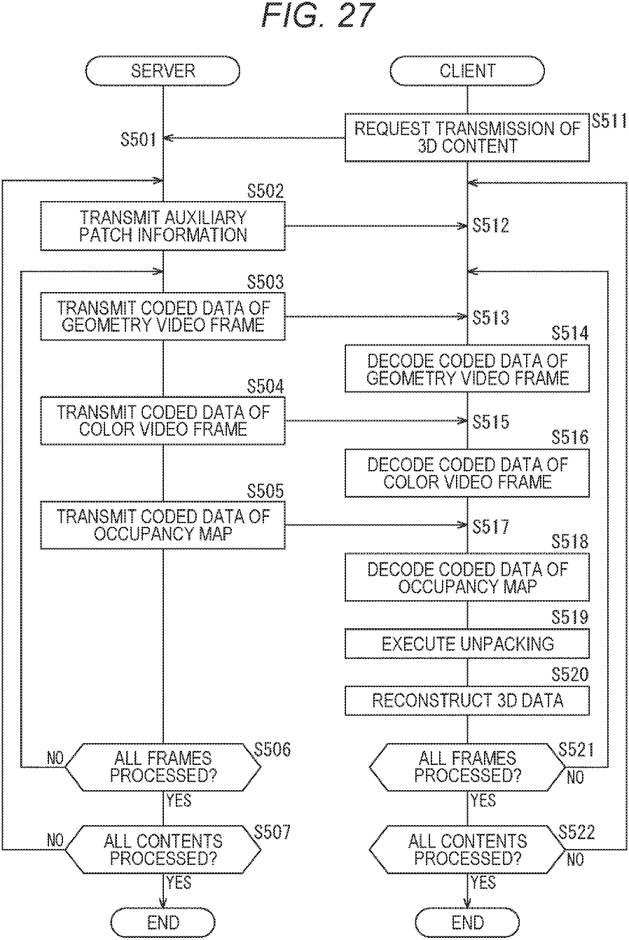

An example of a flow of data transmission processing to be executed by the server 501 and the client 502 in this case will be described with reference to a flowchart in FIG. 27.

If the client 502 requests the transmission of 3D content (Step S511), the server 501 receives the request (Step S501).

If the server 501 transmits auxiliary patch information to the client 502 on the basis of the request (Step S502), the client 502 receives the auxiliary patch information (Step S512).

Then, if the server 501 transmits coded data of a geometry video frame (Step S503), the client 502 receives the coded data (Step S513), and decodes the coded data (Step S514).

Then, if the server 501 transmits coded data of a color video frame (Step S504), the client 502 receives the coded data (Step S515), and decodes the coded data (Step S516).

Then, if the server 501 transmits coded data of an occupancy map (Step S505), the client 502 receives the coded data (Step S517), and decodes the coded data (Step S518) .

As described above, because the server 501 and the client 502 can separately transmit and receive auxiliary patch information, a geometry video frame, a color video frame, and an occupancy map, and decode these pieces of data, these pieces of processing can be easily performed using an existing codec for two-dimensional images.

If data transmission and reception end, the client 502 performs unpacking (Step S519), and reconstructs 3D data (Step S520).

The server 501 performs each piece of processing in steps S503 to S505 on all frames. Then, when it is determined in Step S506 that all frames have been processed, the processing proceeds to Step S507. Then, the server 501 executes each piece of processing in Steps S502 to S507 on each requested content. Then, when it is determined in Step S507 that the requested all contents have been processed, the processing ends.

The client 502 performs each piece of processing in Steps S513 to S521 on all frames. Then, when it is determined in Step S521 that all frames have been processed, the processing proceeds to Step S522. Then, the client 502 executes each piece of processing in Steps S512 to Step S522 on each requested content. Then, when it is determined in Step S522 that the requested all contents have been processed, the processing ends.

By executing each piece of processing as described above, an increase in load of decoding can be suppressed.

### 8. Additional Statement

### Computer

The aforementioned series of processes can be executed by hardware, and can be executed by software. When the series of processes are executed by software, programs constituting the software are installed on a computer. Here, the computer includes a computer built in dedicated hardware, a general-purpose personal computer that can execute various functions by installing various programs, for example, and the like.

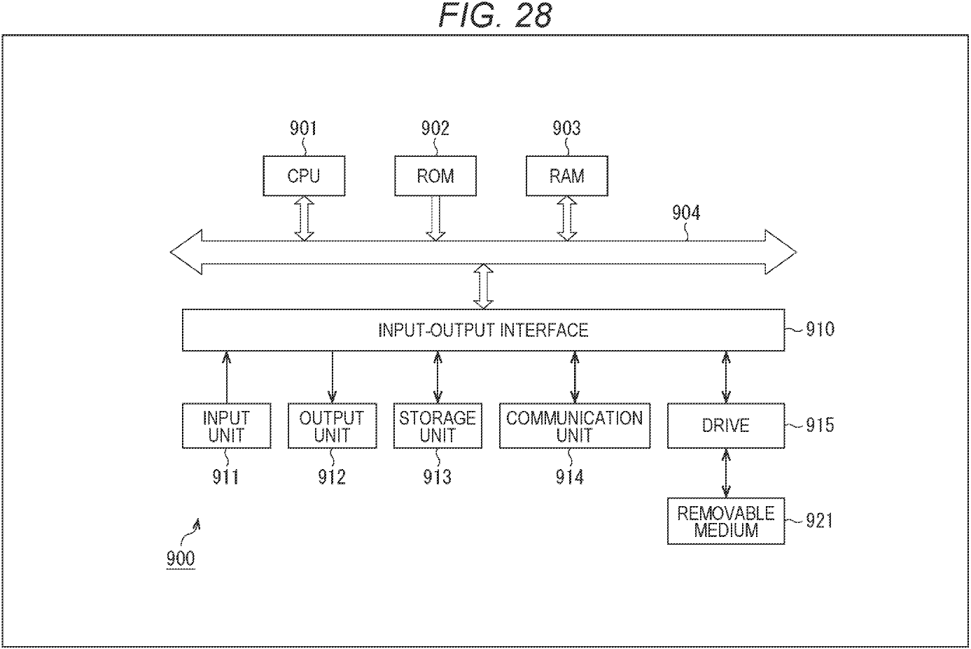

FIG. 28 is a block diagram illustrating a configuration example of hardware of a computer that executes the aforementioned series of processes according to programs.

In a computer 900 illustrated in FIG. 28, a central processing unit (CPU) 901, a read only memory (ROM) 902, and a random access memory (RAM) 903 are connected to one another via a bus 904.

An input-output interface 910 is further connected to the bus 904. An input unit 911, an output unit 912, a storage unit 913, a communication unit 914, and a drive 915 are connected to the input-output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disc, a RAM disc, a nonvolatile memory, and the like. The communication unit 914 includes, for example, a network interface. The drive 915 drives a removable medium 921 such as a magnetic disc, an optical disk, a magneto-optical disk, or a semiconductor memory.

In the computer having the above-described configuration, the aforementioned series of processes are performed by the CPU 901 loading programs stored in, for example, the storage unit 913, onto the RAM 903 via the input-output interface 910 and the bus 904, and executing the programs. Furthermore, pieces of data necessary for the CPU 901 executing various types of processing, and the like are also appropriately stored into the RAM 903.

The programs to be executed by the computer can be applied with being recorded on, for example, the removable medium 921 serving as a package medium or the like. In this case, the programs can be installed on the storage unit 913 via the input-output interface 910 by attaching the removable medium 921 to the drive 915.

Furthermore, the programs can be provided via a wired or wireless transmission medium such as a local area network, the Internet, and digital satellite broadcasting. In this case, the programs can be received by the communication unit 914 and installed on the storage unit 913.

Yet alternatively, the programs can be preinstalled on the ROM 902 and the storage unit 913.

### Application Target of Present Technology

The above description has been given of a case where the present technology is applied to encoding or decoding of point cloud data, but the present technology is not limited to these examples, and can be applied to encoding or decoding of 3D data of an arbitrary standard. That is, unless a conflict with the present technology mentioned above occurs, various types of processing such as an encoding or a decoding method, and the specification of various types of data such as 3D data and metadata are arbitrary. Furthermore, unless a conflict with the present technology occurs, a part of the aforementioned processing or specifications may be omitted.

Furthermore, an encoding device, a decoding device, a server, a client and the like have been described above as application examples of the present technology, but the present technology can be applied to an arbitrary configuration.

For example, the present technology can be applied to various electronic devices such as a transmitter and a receiver (for example, television receiver or mobile phone) in satellite broadcasting, cable broadcasting of a cable TV or the like, delivery on the Internet, and delivery to a terminal by cellular communication, or a device (for example, hard disc recorder or camera) that records images onto media such as an optical disc, a magnetic disc, and a flash memory, and reproduces images from these storage media.

Furthermore, for example, the present technology can also be implemented as a partial configuration of a device such as a processor (for example, video processor) serving as a system Large Scale Integration (LSI) or the like, a module (for example, video module) that uses a plurality of processors and the like, a unit (for example, video unit) that uses a plurality of modules and the like, or a set (for example, video set) obtained by further adding other functions to the unit.

Furthermore, for example, the present technology can also be applied to a network system including a plurality of devices. For example, the present technology may be implemented as cloud computing shared and processed by a plurality of apparatuses in cooperation with each other, via a network. For example, the present technology may be implemented in a cloud service that provides services related to images (moving images) to an arbitrary terminal such as a computer, audio visual (AV) equipment, a portable information processing terminal, and an Internet of Things (IoT) device.

Note that, in this specification, a system means a set of a plurality of constituent elements (apparatuses, modules (parts), and the like), and it does not matter whether or not all the constituent elements are provided in the same casing. Thus, a plurality of apparatuses stored in separate casings and connected via a network, and a single apparatus in which a plurality of modules is stored in a single casing are both regarded as systems.

### Field and Use Application to Which Present Technology Is Applicable

A system, an apparatus, a processing unit, and the like to which the present technology is applied can be used in arbitrary fields such as transit industry, medical industry, crime prevention, agriculture industry, livestock industry, mining industry, beauty industry, industrial plant, home electrical appliances, meteorological service, natural surveillance, for example. Furthermore, the use application is also arbitrary.

### Others

Note that, in this specification, a “flag” is information for identifying a plurality of states, and includes not only information to be used in identifying two states of true (1) or false (0), but also information that can identify three or more states. Accordingly, a value that can be taken by the “flag” may be, for example, two values of ⅟0, or may be three values or more. That is, the number of bits constituting the “flag” may be arbitrary, and may be one bit or a plurality of bits. Furthermore, because it is assumed that identification information (including a flag) not only includes the identification information in a bit stream, but also includes difference information of identification information with respect to reference information in a bit stream, in this specification, the “flag” and the “identification information” include not only information thereof but also include difference information with respect to reference information.

Furthermore, various types of information (metadata, etc.) regarding coded data (bit stream) may be transmitted or recorded in any form as long as the information is associated with coded data. Here, the term “associate” means, for example, enabling use of (linking) one data when the other data is processed. That is, data pieces associated with each other may be combined into a single piece of data, or may be treated as individual pieces of data. For example, information associated with coded data (image) may be transmitted on a different transmission path from that of the coded data (image). Furthermore, for example, information associated with coded data (image) may be recorded onto a different recording medium (or different recording area of the same recording medium) from that of the coded data (image). Note that the “association” may be performed on a part of data instead of the entire data. For example, an image and information corresponding to the image may be associated with each other in an arbitrary unit such as a plurality of frames, one frame, or a portion in a frame.

Note that, in this specification, a term such as “combine”, “multiplex”, “add”, “integrate”, “include”, “store”, “put into”, “inlet”, or “insert” means combining a plurality of objects into one such as combining coded data and metadata into a single piece of data, for example, and means one method of the aforementioned “association”.

Furthermore, an embodiment of the present technology is not limited to the aforementioned embodiment, and various changes can be made without departing from the scope of the present technology.

For example, a configuration described as one apparatus (or processing unit) may be divided, and formed as a plurality of apparatuses (or processing units). In contrast, configurations described above as a plurality of apparatuses (or processing units) may be combined and formed as one apparatus (or processing unit). Furthermore, as a matter of course, a configuration other than the aforementioned configurations may be added to the configuration of each apparatus (or each processing unit). Moreover, as long as the configurations and operations as the entire system remain substantially the same, a part of configurations of a certain apparatus (or processing unit) may be included in the configuration of another apparatus (or another processing unit).

Furthermore, for example, the aforementioned program may be executed in an arbitrary apparatus. In this case, the apparatus is only required to include necessary functions (functional block, etc.) and be enabled to acquire necessary information.

Furthermore, for example, each step of one flowchart may be executed by one apparatus, or may be executed by a plurality of apparatuses while sharing tasks. Moreover, when a plurality of processes is included in one step, the plurality of processes may be executed by one apparatus, or may be executed by a plurality of apparatuses while sharing tasks. In other words, a plurality of processes included in one step can also be executed as processes in a plurality of steps. In contrast, processes described as a plurality of steps can also be collectively executed as one step.

Furthermore, for example, as programs to be executed by the computer, processes in steps describing the programs may be chronologically executed in the order described in this specification. Alternatively, the processes may be performed in parallel, or may be separately performed at necessary timings such as a timing when call-out is performed. That is, unless a conflict occurs, processes in steps may be executed in an order different from the aforementioned order. Moreover, processes in steps describing the programs may be executed in parallel with processes of another program, or may be executed in combination with processes of another program.

Furthermore, for example, a plurality of technologies related to the present technology can be independently and individually executed unless a conflict occurs. As a matter of course, a plurality of the present technologies that is arbitrary can be executed in combination. For example, a part or all of the present technology described in any embodiment can also be executed in combination with a part or all of the present technology described in another embodiment. Furthermore, a part or all of the aforementioned arbitrary present technology can also be executed in combination with another technology not mentioned above.

Note that the present technology can employ the following configurations.
(1) An image processing apparatus including:
   an auxiliary patch information generation unit configured to generate auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud;
   a patch generation unit configured to generate, for each frame in the section, the patch using the auxiliary patch information generated by the auxiliary patch information generation unit; and
   an encoding unit configured to encode a frame image in which the patch generated by the patch generation unit is arranged.
(2) The image processing apparatus according to (1),
   in which the section is an entire sequence.
(3) The image processing apparatus according to (1),
   in which the section is a group of frame (GOF).
(4) The image processing apparatus according to (1),
   in which the auxiliary patch information generation unit generates the auxiliary patch information on the basis of information regarding each frame in the section.
(5) The image processing apparatus according to (1),
   in which the auxiliary patch information generation unit generates the auxiliary patch information on the basis of an external setting.
(6) The image processing apparatus according to (1), further including:
   a flag setting unit configured to set a flag indicating whether to generate the patch of each frame in the section using the common auxiliary patch information,
   in which, when the flag set by the flag setting unit indicates that the patch of each frame in the section is generated using the common auxiliary patch information, the auxiliary patch information generation unit generates the auxiliary patch information in such a manner as to correspond to all frames included in the section, and
   the patch generation unit generates, for each frame in the section, the patch using the auxiliary patch information generated by the auxiliary patch information generation unit.
(7) The image processing apparatus according to claim (6),
   in which, when the flag set by the flag setting unit indicates that the patch of each frame in the section is generated using the auxiliary patch information of each of the frames, the auxiliary patch information generation unit generates the auxiliary patch information for each of the frames included in the section, and
   the patch generation unit generates, for each frame in the section, the patch using the auxiliary patch information corresponding to the frame that has been generated by the auxiliary patch information generation unit.
(8) An image processing method including:
   generating auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud;
   generating, for each frame in the section, the patch using the generated auxiliary patch information; and
   encoding a frame image in which the generated patch is arranged.
(9) An image processing apparatus including:
   an auxiliary patch information holding unit configured to hold auxiliary patch information being information regarding a patch obtained by projecting a point cloud representing a three-dimensional shaped object as an aggregate of points, onto a two-dimensional plane for each partial region that has been used in generation of the patch;
   a patch generation unit configured to generate the patch of a processing target frame of the point cloud using the auxiliary patch information corresponding to the processing target frame, or the auxiliary patch information corresponding to a past frame of the point cloud being a frame processed in a past that is held in the auxiliary patch information holding unit;
   an encoding unit configured to encode a frame image in which the patch generated by the patch generation unit is arranged.
(10) The image processing apparatus according to claim (9), further including:
   a flag setting unit configured to set a flag indicating whether to generate the patch of the processing target frame using the auxiliary patch information corresponding to the past frame,
   in which, when the flag set by the flag setting unit indicates that the patch of the processing target frame is generated using the auxiliary patch information corresponding to the past frame, the patch generation unit generates the patch of the processing target frame using the auxiliary patch information corresponding to the past frame that is held in the auxiliary patch information holding unit.
(11) The image processing apparatus according to (10),
   in which, when the flag set by the flag setting unit indicates that the patch of the processing target frame is not generated using the auxiliary patch information corresponding to the past frame, the patch generation unit generates the auxiliary patch information corresponding to the processing target frame, and generates the patch of the processing target frame using the generated auxiliary patch information.
(12) An image processing method including:
   holding auxiliary patch information being information regarding a patch obtained by projecting a point cloud representing a three-dimensional shaped object as an aggregate of points, onto a two-dimensional plane for each partial region that has been used in generation of the patch;
   generating the patch of a processing target frame of the point cloud using the auxiliary patch information corresponding to the processing target frame, or the held auxiliary patch information corresponding to a past frame of the point cloud being a frame processed in a past; and
   encoding a frame image in which the generated patch is arranged.
(13) An image processing apparatus including:
   an auxiliary patch information decoding unit configured to decode coded data and generate auxiliary patch information being information regarding a patch obtained by projecting a point cloud representing a three-dimensional shaped object as an aggregate of points, onto a two-dimensional plane for each partial region;
   an auxiliary patch information holding unit configured to hold the auxiliary patch information generated by the auxiliary patch information decoding unit; and
   a reconstruction unit configured to reconstruct the point cloud of a plurality of frames using the mutually-identical auxiliary patch information held in the auxiliary patch information holding unit.
(14) The image processing apparatus according to (13),
   in which the reconstruction unit reconstructs the point cloud of each frame in the section using the auxiliary patch information corresponding to all of a plurality of frames included in a predetermined section in a time direction of the point cloud that is held in the auxiliary patch information holding unit.
(15) The image processing apparatus according to (14),
   in which the section is an entire sequence.
(16) The image processing apparatus according to (14),
   in which the section is a group of frame (GOF).
(17) The image processing apparatus according to (14),
   in which, when a flag indicates that the point cloud of each frame in the section is reconstructed using the common auxiliary patch information, the reconstruction unit reconstructs the point cloud of each frame in the section using the auxiliary patch information corresponding to all frames in the section that is held in the auxiliary patch information holding unit.
(18) The image processing apparatus according to (13),
   in which the reconstruction unit reconstructs the point cloud of a processing target frame using the auxiliary patch information corresponding to a past frame being a frame processed in a past that is held in the auxiliary patch information holding unit.
(19) The image processing apparatus according to (18),
   in which, when a flag indicates that the point cloud of the processing target frame is generated using the auxiliary patch information corresponding to the past frame, the reconstruction unit reconstructs the point cloud of the processing target frame using the auxiliary patch information corresponding to the past frame that is held in the auxiliary patch information holding unit.
(20) An image processing method including:
   decoding coded data and generating auxiliary patch information being information regarding a patch obtained by projecting a point cloud representing a three-dimensional shaped object as an aggregate of points, onto a two-dimensional plane for each partial region;
   holding the generated auxiliary patch information; and
   reconstructing the point cloud of a plurality of frames using the held mutually-identical auxiliary patch information.

### REFERENCE SIGNS LIST

100 Encoding device
101 Auxiliary patch information generation unit
111 Patch decomposition unit
112 Packing unit
113 Auxiliary patch information compression unit
114 and 115 Video encoding unit
116 OMap encoding unit
117 Multiplexer
150 Decoding device
161 Demultiplexer
162 Auxiliary patch information decoding unit
163 Auxiliary patch information holding unit
164 and 165 Video decoding unit
166 OMap decoding unit
167 Unpacking unit
168 3D reconstruction unit
200 Encoding device
201 Auxiliary patch information holding unit
250 Encoding device
251 Flag setting unit
300 Encoding device
301 Flag setting unit
500 Image processing system
501 Server
502 Client
503 Network
511 Transmission unit
521 Receiving unit

1. An image processing apparatus comprising:
an auxiliary patch information generation unit configured to generate auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud;
a patch generation unit configured to generate, for each frame in the section, the patch using the auxiliary patch information generated by the auxiliary patch information generation unit; and
an encoding unit configured to encode a frame image in which the patch generated by the patch generation unit is arranged.

2. The image processing apparatus according to claim 1,
wherein the section is an entire sequence.

3. The image processing apparatus according to claim 1,
wherein the section is a group of frame (GOF).

4. The image processing apparatus according to claim 1,
wherein the auxiliary patch information generation unit generates the auxiliary patch information on a basis of information regarding each frame in the section.

5. The image processing apparatus according to claim 1,
wherein the auxiliary patch information generation unit generates the auxiliary patch information on a basis of an external setting.

6. The image processing apparatus according to claim 1, further comprising:
a flag setting unit configured to set a flag indicating whether to generate the patch of each frame in the section using the common auxiliary patch information,
wherein, when the flag set by the flag setting unit indicates that the patch of each frame in the section is generated using the common auxiliary patch information, the auxiliary patch information generation unit generates the auxiliary patch information in such a manner as to correspond to all frames included in the section, and
the patch generation unit generates, for each frame in the section, the patch using the auxiliary patch information generated by the auxiliary patch information generation unit.

7. The image processing apparatus according to claim 6,
wherein, when the flag set by the flag setting unit indicates that the patch of each frame in the section is generated using the auxiliary patch information of each of the frames, the auxiliary patch information generation unit generates the auxiliary patch information for each of the frames included in the section, and
the patch generation unit generates, for each frame in the section, the patch using the auxiliary patch information corresponding to the frame that has been generated by the auxiliary patch information generation unit.

8. An image processing method comprising:
generating auxiliary patch information being information regarding a patch obtained by projecting a point cloud representing a three-dimensional shaped object as an aggregate of points, onto a two-dimensional plane for each partial region, in such a manner as to correspond to all of a plurality of frames included in a predetermined section in a time direction of the point cloud;
generating, for each frame in the section, the patch using the generated auxiliary patch information; and
encoding a frame image in which the generated patch is arranged.

9. An image processing apparatus comprising:
an auxiliary patch information holding unit configured to hold auxiliary patch information being information regarding a patch obtained by projecting a point cloud representing a three-dimensional shaped object as an aggregate of points, onto a two-dimensional plane for each partial region that has been used in generation of the patch;
a patch generation unit configured to generate the patch of a processing target frame of the point cloud using the auxiliary patch information corresponding to the processing target frame, or the auxiliary patch information corresponding to a past frame of the point cloud being a frame processed in a past that is held in the auxiliary patch information holding unit; and
an encoding unit configured to encode a frame image in which the patch generated by the patch generation unit is arranged.

10. The image processing apparatus according to claim 9, further comprising:
a flag setting unit configured to set a flag indicating whether to generate the patch of the processing target frame using the auxiliary patch information corresponding to the past frame,
wherein, when the flag set by the flag setting unit indicates that the patch of the processing target frame is generated using the auxiliary patch information corresponding to the past frame, the patch generation unit generates the patch of the processing target frame using the auxiliary patch information corresponding to the past frame that is held in the auxiliary patch information holding unit.

11. The image processing apparatus according to claim 10,
wherein, when the flag set by the flag setting unit indicates that the patch of the processing target frame is not generated using the auxiliary patch information corresponding to the past frame, the patch generation unit generates the auxiliary patch information corresponding to the processing target frame, and generates the patch of the processing target frame using the generated auxiliary patch information.

12. An image processing method comprising:
holding auxiliary patch information being information regarding a patch obtained by projecting a point cloud representing a three-dimensional shaped object as an aggregate of points, onto a two-dimensional plane for each partial region that has been used in generation of the patch;
generating the patch of a processing target frame of the point cloud using the auxiliary patch information corresponding to the processing target frame, or the held auxiliary patch information corresponding to a past frame of the point cloud being a frame processed in a past; and
encoding a frame image in which the generated patch is arranged.

13. An image processing apparatus comprising:
an auxiliary patch information decoding unit configured to decode coded data and generate auxiliary patch information being information regarding a patch obtained by projecting a point cloud representing a three-dimensional shaped object as an aggregate of points, onto a two-dimensional plane for each partial region;
an auxiliary patch information holding unit configured to hold the auxiliary patch information generated by the auxiliary patch information decoding unit; and
a reconstruction unit configured to reconstruct the point cloud of a plurality of frames using the mutually-identical auxiliary patch information held in the auxiliary patch information holding unit.

14. The image processing apparatus according to claim 13,
wherein the reconstruction unit reconstructs the point cloud of each frame in the section using the auxiliary patch information corresponding to all of a plurality of frames included in a predetermined section in a time direction of the point cloud that is held in the auxiliary patch information holding unit.

15. The image processing apparatus according to claim 14,
wherein the section is an entire sequence.

16. The image processing apparatus according to claim 14,
wherein the section is a group of frame (GOF).

17. The image processing apparatus according to claim 14,
wherein, when a flag indicates that the point cloud of each frame in the section is reconstructed using the common auxiliary patch information, the reconstruction unit reconstructs the point cloud of each frame in the section using the auxiliary patch information corresponding to all frames in the section that is held in the auxiliary patch information holding unit.

18. The image processing apparatus according to claim 13,
wherein the reconstruction unit reconstructs the point cloud of a processing target frame using the auxiliary patch information corresponding to a past frame being a frame processed in a past that is held in the auxiliary patch information holding unit.

19. The image processing apparatus according to claim 18,
wherein, when a flag indicates that the point cloud of the processing target frame is generated using the auxiliary patch information corresponding to the past frame, the reconstruction unit reconstructs the point cloud of the processing target frame using the auxiliary patch information corresponding to the past frame that is held in the auxiliary patch information holding unit.

20. An image processing method comprising:
decoding coded data and generating auxiliary patch information being information regarding a patch obtained by projecting a point cloud representing a three-dimensional shaped object as an aggregate of points, onto a two-dimensional plane for each partial region;
holding the generated auxiliary patch information; and
reconstructing the point cloud of a plurality of frames using the held mutually-identical auxiliary patch information.
